(19) United States
(12) Patent Application Publication
(10) Pub. No.: US 2025/0224308 A1
(43) Pub. Date: Jul. 10, 2025

(54) BACKSPUTTER MITIGATION IN ELECTRIC PROPULSION TESTING

(71) Applicants: Seth Thompson, Ann Arbor, MI (US); John Williams, Ann Arbor, MI (US); The Regents of the University of Michigan, Ann Arbor, MI (US)

(72) Inventors: Seth Thompson, Ft. Collins, CO (US); John Williams, Ft. Collins, CO (US); Christopher May, Ann Arbor, MI (US); William Hurley, Ann Arbor, MI (US); Collin Whittaker, Ann Arbor, MI (US); Benjamin Jorns, Ann Arbor, MI (US)

(21) Appl. No.: 19/013,632

(22) Filed: Jan. 8, 2025

Related U.S. Application Data
(60) Provisional application No. 63/618,721, filed on Jan. 8, 2024.

(51) Int. Cl. G01M 15/02; B64G 1/40; H05H 7/04

(52) U.S. Cl. CPC G01M 15/02; B64G 1/413; H05H 7/04; H05H 2007/046

(57) ABSTRACT

A system for mitigating backsputter to a thruster in a propulsion test facility includes a plate disposed in an output plume of the thruster and a magnetic field generator disposed about or at the plate and configured to generate a magnetic field between the thruster and the plate. The magnetic field generator is oriented such that a magnetic field is generated transverse to the output plume.

### CROSS-REFERENCE TO RELATED APPLICATION

This application claims the benefit of U.S. provisional application entitled “Backsputter Mitigation in Electric Propulsion Testing,” filed Jan. 8, 2024, and assigned Ser. No. 63/618,721, the entire disclosure of which is hereby expressly incorporated by reference.

### STATEMENT REGARDING FEDERALLY SPONSORED RESEARCH OR DEVELOPMENT

This invention was made with government support under Contract No. 80NSSC21K1118 awarded by the National Aeronautics and Space Administration. The government has certain rights in the invention.

### BACKGROUND OF THE DISCLOSURE

### Field of the Disclosure

The disclosure relates generally to electric propulsion devices.

### Brief Description of Related Technology

The increasing lifetime of electric propulsion (EP) devices has rendered full-length lifetime qualification tests impractical in terms of both time and available funding—and very high power thrusters are making ground-based testing more unfeasible due to the requirements for increased vacuum chamber size and pumping capacity to avoid excessive test facility background pressures and excessive thruster contamination from sputtering of the chamber beam target and wall. As a result, a premium has been placed on developing models and using them to interpret performance and erosion rates measured during limited-duration testing at higher than desired facility pressure under conditions of higher than desired backsputter rates. The hope is that the models could then be used to predict performance and lifetime expected in space. Success of this strategy would negate the need to operate the device to end-of-life. The risk to this approach is that backsputter rates will be too high to obtain high quality measurements of performance and erosion rates.

There are concerns about the fidelity of the limited-duration, ground-based tests and the ability to use these results to predict in-space performance and lifetime. In both gridded ion and Hall thrusters, sputter erosion of the devices that result from the operation of the device itself is their life-limiting mechanism—at least in space. To quantify this, limited-duration wear tests are often utilized to determine the erosion rates of life-limiting components. This process of measuring erosion of the thruster through limited-duration testing can be significantly impacted by the deposition of sputtered material from facility surfaces onto the thruster, often referred to as the backsputter of the facility. This rate has been estimated to be on the order of the erosion rate in 12.5 kW Hall thruster tests. Furthermore, accelerated testing performed with beam targets placed closer to the thruster, where backsputter rates are significantly increased, discovered that the film growth rate of the backsputtered material will likely stymie limited-duration wear tests. This problem is only further exacerbated by increases in EP device power that produce higher current and/or energetic beams that further increase the rate of backsputter to the thruster. Lastly, increased demand for lower-cost propellants has resulted in efforts to qualify EP devices on krypton and argon gasses that are expected to have enhanced sputter rates due to better momentum transfer as sputter targets, usually carbon, and ion atomic masses grow more similar. While higher fidelity models are being developed to quantify this effect, experimental efforts are underway to mitigate the problem and provide useful datasets for model validation efforts.

Approaches to reduce the backsputter rate of the thruster under test have been explored for some time, with the use of graphite, a low sputter yield material, and angled beam dump designs being standard practice in many high-power EP test facilities. New approaches for reducing backsputter, such as using volumetrically complex materials (VCMs) to trap sputtered particles in the materials themselves, are also being explored and numerical simulation of surface evolutions morphology have shown initial sputter yield reduction under normal incident ion bombardment. It is still unclear if the use of these materials will be feasible to scale to the sizes needed for large vacuum facilities or if they will be able to retain a low sputter yield throughout a limited-duration test.

### SUMMARY OF THE DISCLOSURE

In accordance with one aspect of the disclosure, a system for mitigating backsputter to a thruster in a propulsion test facility includes a plate disposed in an output plume of the thruster, and a magnetic field generator disposed about or at the plate and configured to generate a magnetic field between the thruster and the plate. The magnetic field generator is oriented such that a magnetic field is generated transverse to the output plume.

In accordance with another aspect of the disclosure, a method for mitigating backsputter to a thruster in a propulsion test facility includes disposing a plate in an output plume of the thruster between the thruster and the plate, and generating a magnetic field transverse to the output plume.

In connection with any one of the aforementioned aspects, the systems and/or methods described herein may alternatively or additionally include or involve any combination of one or more of the following aspects or features. The magnetic field generator includes a plurality of solenoids disposed about the plate. The magnetic field has a magnitude sufficient to trap electrons in the output plume. The magnetic field has a magnitude insufficient to trap ions in the output plume. The magnetic field has a magnitude falling in a range between 0 Gauss to about 200 Gauss. The plate is electrically floating. The plate is spaced from the thruster by an axial distance falling in a range that corresponds to about 1 thruster diameter to about 10 thruster diameters. The system further includes a power source coupled to the plate to electrically bias the plate. The plate is oriented perpendicularly to an axis of the output plume. The plate is oriented at a non-perpendicular angle to an axis of the output plume. The magnetic field generator includes a plurality of permanent magnets. The magnetic field generator is oriented such that the magnetic field is parallel to a surface of the plate. Generating the magnetic field includes driving a plurality of solenoids disposed about the plate. The method further includes applying a bias voltage to the plate. Disposing the plate includes orienting the plate at a non-perpendicular angle to an axis of the output plume. The method further includes sequestering gas from a chamber of the propulsion test facility.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts an ion thruster in reverse (part (a)) and Hall thruster in reverse (part (b)) in a picket fence configuration with cross-sections assumed to extend into the page.

FIG. 2 is a schematic view of an induced magnetic field beam halter system in accordance with one example.

FIG. 3 depicts in part (a) a photograph of the magnetic mapping setup and in part (b) a resultant contour plot of magnetic field strength between two rows of magnets.

FIG. 4 depicts in part (a) ion current density measurements downstream of a converging ion beam grid set with annotated axial test locations for an example beam halter evaluation, and in part (b) a photograph of the example beam halter under test at the closest 210 mm test location.

FIG. 5 depicts in part (a) a quarter view of the potential profile of an example picket-fence magnetic configuration beam halter system with a 200V bias applied to the ion energy suppression plate, and in part (b) a photograph of experimental example used in 8-cm gridded ion source testing.

FIG. 6 depicts in part (a) a graphical plot of predicted sputter-capable fluence to the Halter plate, and in part (b) depicts a graphical plot of simulated backsputter rate of graphite from an example picket-fence-configuration beam halter system held 1 m downstream of a 1.5 kW Hall thruster operated at 300V with the ion energy suppression plate assumed to be 200V.

FIG. 7 depicts graphical plots of ion energy suppression plate current with respect to applied bias for a 210 mm test location in part (a) and a 310 mm test location in part (b).

FIG. 8 is a graphical plot of ion energy suppression plate current with respect to applied bias at 410 mm axial distance from the gridded ion source.

FIG. 9 is a graphical plot of floating voltage of a beam halter ion energy suppression plate with respect to axial location downstream of the ion source.

FIG. 10 is a graphical plot of relative changes to the backsputter rate as the beam halter ion energy suppression plate bias is increased during operation at 600V beam condition.

FIG. 11 is a graphical plot of simulated effect of background pressure on backsputter reduction of an example beam halter system compared to a grounded graphite plate with no magnetic field.

FIG. 12 is a graphical plot of simulated fraction of backsputtered material at two operating voltages with respect to the applied ion energy suppression plate bias relative to a grounded graphite plate with no magnetic field.

FIG. 13 is a graphical plot of fit of the current-voltage model to the experimentally collected I/V curves collected 410 mm away from the 8-cm ion source.

FIG. 14 is a graphical plot of model fit to the 200V beam voltage I/V trace collected at the 410 mm location with reference curves representing weaker and stronger magnetic fields.

FIG. 15 depicts graphical plots of fits to the 310 mm (part (a)) and 210 mm (part (b)) experimentally collected I/V curves, with weaker B-fields allowed.

FIG. 16 is a graphical plot of model results for varied ion current density to the Halter compared to the 200V beam voltage fit.

FIG. 17 is a graphical plot of normalized negative derivative of the ion energy suppression plate current with respect to applied voltage

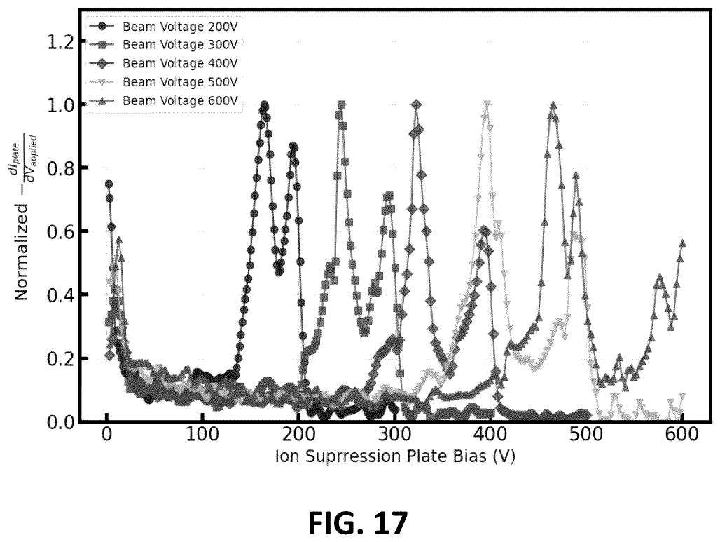

$$- \frac{dI}{dV} ,$$

representing ion energy distributions arriving to the plate.

FIG. 18 is a schematic view of operation of a beam halter in accordance with one example. The transverse field impedes electrons, and the plate voltage (floating or biased) slows down beam ions.

FIG. 19 is a perspective view of a beam halter assembly in accordance with one example.

FIG. 20 is a top-down (plan) view of transverse B-field component strength.

FIG. 21 depicts B-field uniformity demonstrated through a plot of 3D streamlines in part (a) and a 2D plot along a line running horizontally in the interior of the coils in part (b).

FIG. 22 depicts a graphical plot of predicted average transverse field strength along the same line as FIG. 21, part (b), as a function of current.

FIG. 23 depicts a beam halter in accordance with one example setup in a test facility (Large Vacuum Test Facility), including the notional positions of the thruster on an axial motion stage, beam halter, quartz crystal microbalance (QCM), and ion gauge.

FIG. 24 depicts a QCM mounted in plane with the thruster with a radiation shield and active cooling to maintain thermal stability.

FIG. 25 depicts a circuit diagram to monitor the floating voltage or bias the graphite plate in the beam halter.

FIG. 26 depicts operation of an example beam halter with a coil current of 0 A in part (a), 2 A in part (b), 4 A in part (c), and 6 A in part (d). The Hall thruster is operated on krypton at 200 V, 15 A with the graphite plate floating.

FIG. 27 depicts graphical plots of floating voltage of the graphite plate (with respect to cathode) in part (a), and cathode to ground voltage as a function of solenoid current in part (b), with the thruster operating in multiple configurations.

FIG. 28 depicts graphical plots of deposition and heating rate on the QCM with the graphite plate floating as a function beam Halter current, with a) 300 V, b) 200 V, c) 300 V far field, and d) 300 V body tied.

FIG. 29 depicts graphical plots of a) cathode to ground voltage and collected current as a function of the graphite plate bias (ground referenced), and b) deposition and heating rate on the QCM as a function of bias voltage. For all conditions, the thruster is operated on krypton and 300 V, 15 A with the cathode and body independently floating.

FIG. 30 is a flow diagram of a method of mitigating backsputter in accordance with one example.

The embodiments of the disclosed systems and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Beam halter systems and methods for backsputter mitigation in electric propulsion testing are described. The disclosed systems and methods are based on an active mitigation strategy that uses electric and/or magnetic fields to slow incoming ions and shield electric fields from affecting plume properties, thereby limiting the effects of the bias applied to a downstream surface on thruster and beam plasma properties. The disclosed beam halter systems and methods may be considered a “beam catcher” that slows the incoming ions but limits any interaction with the thruster, the beam plasma, and the test facility.

An active mitigation approach slows down the incident beam ions before they impact surfaces by use of electric fields. Previous tests have explored the effect of biasing a large area beam dump with respect to chamber ground to determine its effect on the thruster operation. This testing revealed increases in beam plasma potential and collection of amperes of beam plasma electrons commensurate with the magnitude of the bias applied to the beam dump. This would therefore have little to no effect on the backsputter rate to the thruster as ions generated at potentials higher than the plume plasma would still arrive at the surface with sufficient energy to sputter the beam target.

Described herein are examples of systems and methods for reducing backsputter to thrusters from a test facility beam target and wall. The disclosed systems may be referred to herein as a Hall thruster in reverse (a “halter”). In some cases, the disclosed systems may use a transverse magnetic field applied with a picket-fence configuration of permanent magnets. Alternatively or additionally, the disclosed systems may include a positively biased plate that is buried within the structure for slowing beam ions, thus reducing sputtering, while the transverse magnetic field restricts the flow of electrons from the beam plasma to the plate, preventing the halter from perturbing thruster operation. The transverse magnetic field configuration and the sputter mitigation aspects of the disclosed systems are further explained below, and its expected effectiveness in terms of reduced backsputter to the thruster is described using two models-one model (a target sputter model) is used to predict backsputtering from the halter and a separate model (a current-voltage model) is used to predict the ion and electron currents flowing to the buried plate of the beam halter. The target sputter model is exercised to estimate the effectiveness of the beam halter across plate biases and background pressures, while the current-voltage model is used to relate measured IN characteristics to incoming plume plasma parameters and device configuration. Measurements are presented of the net current flowing to the buried plate in a small-scale example of the beam halter system tested in the beam of a gridded ion source as a function of the buried plate voltage, beam ion energy, and axial position relative to the ion source. At low plate biases, net ion current is detected, and the current decreases with increasing plate bias as beam plasma electrons cross the transverse field region to reach the buried plate. It was observed that the halter plate floating potential (the point on the IN curve where the net current is zero) increased dramatically as the halter system was moved axially away from the ion source to regions of lower ion beam current density and plasma density. One useful feature of the beam halter system is the floating potential of the buried plate-high floating potentials imply significantly slowed ions and reduced sputtering while minimizing perturbations of the halter on electrical interactions between the thruster and the test facility.

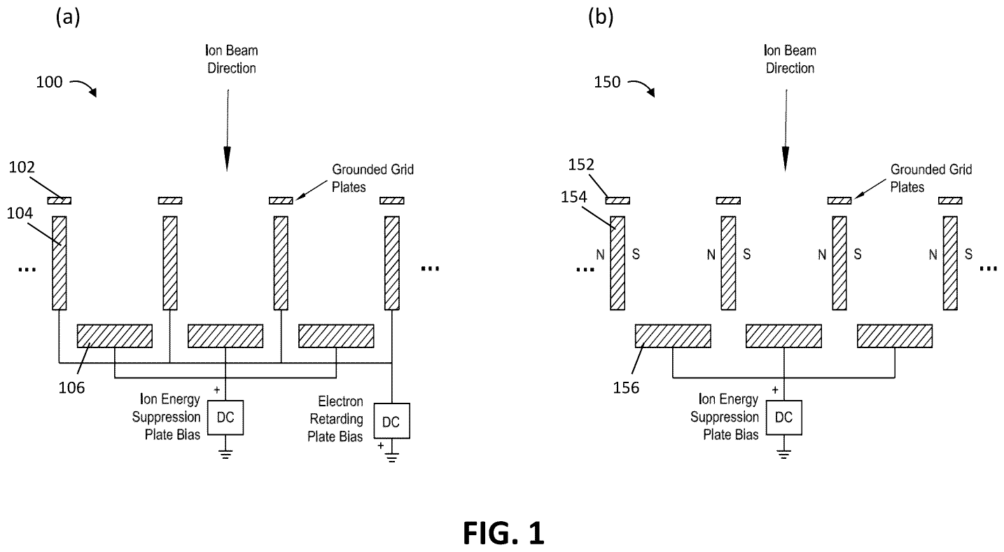

Two approaches to beam catching are the “ion thruster in reverse” and the “Hall thruster in reverse” (“halter”) backsputter mitigation systems, which are described below. These systems can be configured in several ways, and examples of both the ion thruster in reverse and the halter backsputter mitigation systems are shown in FIG. 1. FIG. 1, part (a) shows an example configuration of an ion thruster in reverse backsputter mitigation system 100. FIG. 1, part (b) illustrates an example configuration of a halter backsputter mitigation system 150. The systems 100, 150 operate using grounded grid plates, and either magnets or electron retarding plates, with appropriate spacing to limit the direct coupling of plume electrons to the positively biased ion energy suppression plate. For example, the ion thruster in reverse backsputter mitigation system 100 may use electron retarding plates 104, and the halter backsputter mitigation system 150 may use permanent magnets 154. The electron retarding plates 104 of the ion thruster in reverse approach in FIG. 1, part (a), are shielded by grounded grid plates 102 (also referred to as a ground plate). The retarding plates 104, grounded plates 102, and suppression plates 106 are shown in cross-section for ease in illustration. With respect to the halter approach, the permanent magnets 154 of the halter approach in FIG. 1, part (b), are shielded by grounded grid plates 152 made from graphite. The line of magnets 154, grounded plates 152, and suppression plates 156 are assumed to extend into the page. This configuration of the halter design may be referred to as a “picket-fence” magnetic configuration and relies on the magnets 154 to produce a sufficient transverse magnetic field across the surfaces of the ion energy suppression plates 156 to limit plume electrons from arriving at the plate surfaces.

The grounded grid plates 102, 152 in FIG. 1 would still be sputtered by particles with the full ion beam energy, but ions that flow in between the grid plates 102, 152 would be slowed by the electric field generated by the electron retarding plates 104 in part (a) or magnets 154 in part (b) between the suppressor plate 106, 156 and plume plasma before arriving at the surface of the ion energy suppression plate 106, 156. This potential could be set to near that of the anode voltage in a Hall thruster (HT) to slow most incoming ions to energies below the sputter threshold of the plate material. However, there may be a limit to the applied plate bias before interaction with the beam plasma occurs. The precipitous drop of sputter yield of many materials at low energies indicates that decreasing the incoming ion energy by a modest fraction may be all that is necessary to decrease the backsputter rates to more acceptable levels.

Another example configuration of the halter approach utilizes an applied magnetic field from (e.g., generated by) one or more solenoidal structures placed around or beneath an ion energy suppression plate. This configuration of the halter approach may be referred to as a “solenoidal configuration”. The applied magnetic field from the one or more solenoids may eliminate, minimize, or drastically reduce the exposed area of grounded support structures (e.g., grounded grid plates 102, 152 shown in FIG. 1) that can be hit by incoming ions.

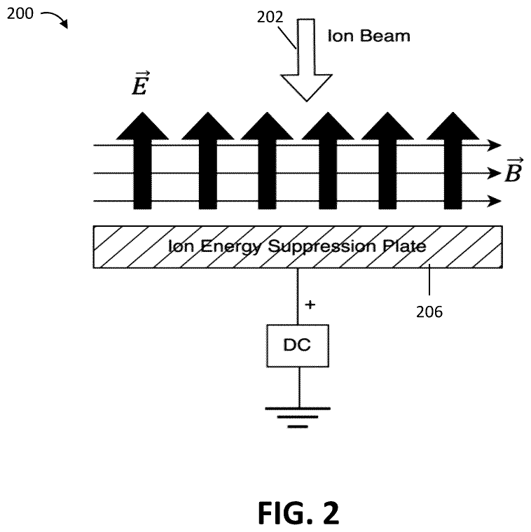

FIG. 2 shows an example of a solenoid-based halter system 200 with no grounded surfaces over an ion energy suppression plate 206 and with solenoidal structures (not shown in FIG. 2) that may be disposed out (e.g., outward) of an ion beam 202 with no shadowing of the ion energy suppression plate 206. In other words, the solenoidal structure may be spaced from the ion beam 202 and disposed or located relative to the energy suppression plate 206 such that the solenoidal structure does form an obstacle between the source of the ion beam 202 and the ion energy suppression plate 206. Elimination of the ground plates may also simplify construction while enabling variable magnetic field strengths to be tested, aiding in characterization efforts.

As described above in connection with the examples of FIGS. 1 and 2, the disclosed systems for mitigating backsputter to a thruster in a propulsion test facility may include a plate disposed in an output plume of the thruster, and a magnetic field generator disposed at or about the plate and configured to generate a magnetic field between the thruster and the plate. The magnetic field generator may be oriented such that the magnetic field is transverse to the output plume. In some cases, the magnetic field generator may generate a magnetic field parallel to the plate.

The disclosed systems for mitigating backsputter to the thruster in the propulsion test facility may have various configurations such as configurations of the halter system described, evaluated, tested, investigated, and/or simulated herein. For example, the configurations of the halter system may include, but are not limited to, the “picket-fence” magnetic configuration, the solenoidal configuration, or the like. Herein after, the halter system may also be simply referred to as a “halter” or a “beam halter.”

The expected effectiveness of these backsputter mitigation systems are influenced by several factors, such as the open area fraction between the grounded grid plates in the picket fence configuration, the magnetic field strength, the bias of the ion energy suppression plate, and the neutral background pressure, and the like. An approach for evaluating the strength that each factor has on overall effectiveness of reducing backsputtering is developed below. For a beam catcher to be feasible, it is useful to show that the sputter mitigation strategy employed has limited or no impact on test fidelity via plume interactions or other thruster effects. These topics are described herein with the application of a simplified beam halter model and a scaled example system operated downstream of a gridded ion source. A number of example picket fence halter systems with a gridded ion test facility are described below. The model that was employed to determine expected effectiveness and guide further development is also described below. This includes a description of the expected back sputter reduction under various conditions and a model used for fitting the collected current versus applied voltage of the ion energy suppression plate of the example beam halter system. The results of these simulations and testing in the beam of a gridded ion source are also described below.

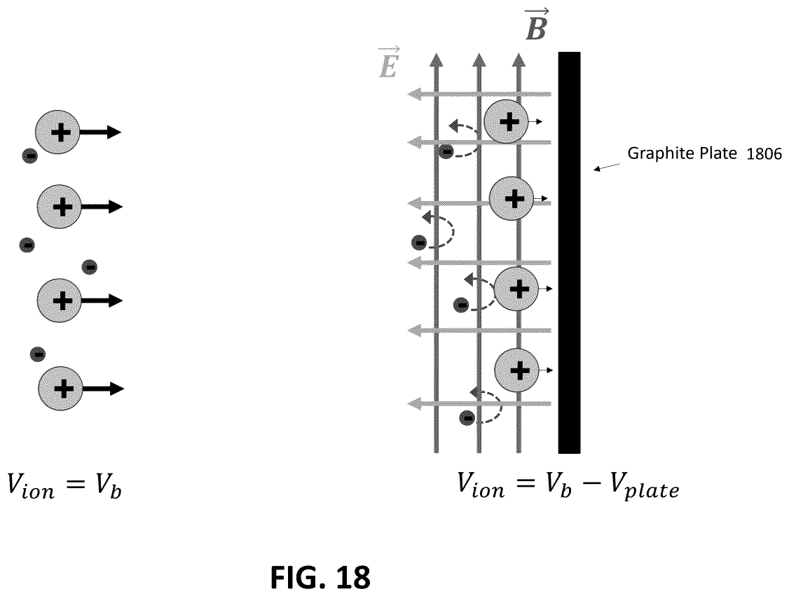

Two example configurations of the halter system were produced for testing. Both rely on applied magnetic fields from either solenoids or permanent magnets to produce a magnetic field parallel to the isolated ion energy suppression plate surface. In these configurations, the bias applied to the ion energy suppression plate creates an electric field (as shown with f in FIG. 2) perpendicular to the applied magnetic field (indicated with B in FIG. 2) and antiparallel to the incident beam ions 202 as shown in FIG. 2. In these configurations, the only surface exposed to ions with full beam energies are structures related to supporting the generation of the applied magnetic field (e.g., solenoid components or covers or permanent magnets). In an alternative example, remotely located (e.g., spaced from the beam) solenoids are used to generate the magnetic field, which have the advantage of large transparency, decreasing the area of surfaces sputtered by full beam energy ions. Examples of a solenoidal system with the remotely located solenoids were constructed, with details and testing results described below in connection with FIGS. 18-29.

Halter system with a “picket-fence” configuration. In one example, the halter system uses lines of permanent magnets that are placed facing one another (north to south) with the open area between them considered the open area through which ions will flow until they encounter the ion energy suppression plate, as shown in FIG. 1, part (b)—the “picket-fence” configuration. Referring to FIG. 1, part (b), The magnets 154 in the picket fence halter system 150 are used to apply the magnetic field parallel (transverse) to the surface of the ion energy suppression plate 156.

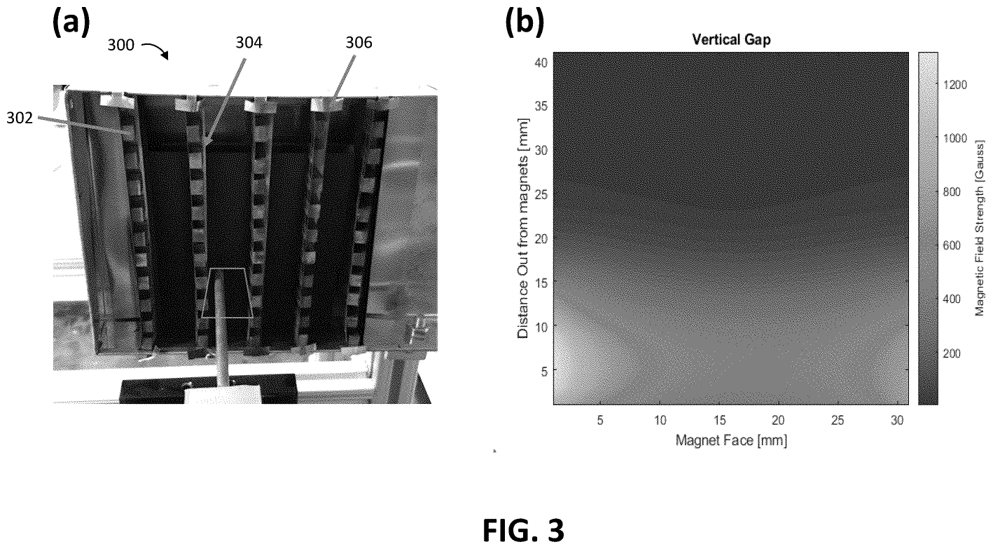

An example 300 of the “picket-fence” configuration was constructed for evaluation in the beam of an 8-cm ion source and is shown in FIG. 3, part (a). The example 300 included 5 rows 304 of magnets 302 with 10 SmCo-26 magnets per row. The rows 304 are spaced roughly 3.3-cm apart across an 18 cm long and 20 cm wide area. The row length exposed to the beam was roughly 20 cm. This example 300 of the “picket-fence” configuration for halter system includes the grounded graphite strips protecting the magnets are 1.3 cm wide, which are not shown in FIG. 3 to show the magnets. The magnetic field of the open area between the lines of permanent magnets was mapped, with the magnitude of the field shown in FIG. 3, part (b). The resulting transparency of the active area of the example of halter picket-fence system was roughly 0.73. The number, size, arrangement, and other characteristics of the magnets may vary in other cases.

All exposed stainless steel and magnet rows were covered with thin graphite plates before testing of the halter in the beam of the ion source. The majority of the exposed region of the halter to the ion beam was graphite apart from stainless steel ground plate retainer brackets 306 (shown at the ends of each row 304 of FIG. 3, part (a)). The temperature of the halter was not monitored, although post-test measurement of the magnetic fields indicated no degradation of the permanent magnets was observed.

Gridded ion source test facility. An 8-cm gridded ion source was utilized in a vacuum facility to evaluate the picket-fence halter example. The test facility had a pumping speed of 1000 L/s on argon. The 8-cm gridded ion source utilized an additively manufactured titanium grid-set. The grid-set was printed with a concave dish for creating a focused, narrow-waisted ion beam at test locations of interest. The gridded ion source utilized a tungsten filament cathode for the discharge and a hollow cathode for the neutralizer. The ion source was operated on argon at the same flows—4 sccm to the source and 2.5 sccm to the neutralizer—and at a beam current of 50 mA across all tests performed in the present study. Full Halter I-V curves were recorded at each of three axial locations as the beam voltage was adjusted from 200V to 600V in 100V increments. In addition, the halter was translated in the z-direction while the floating voltage was measured for all of the gridded ion beam operating conditions.

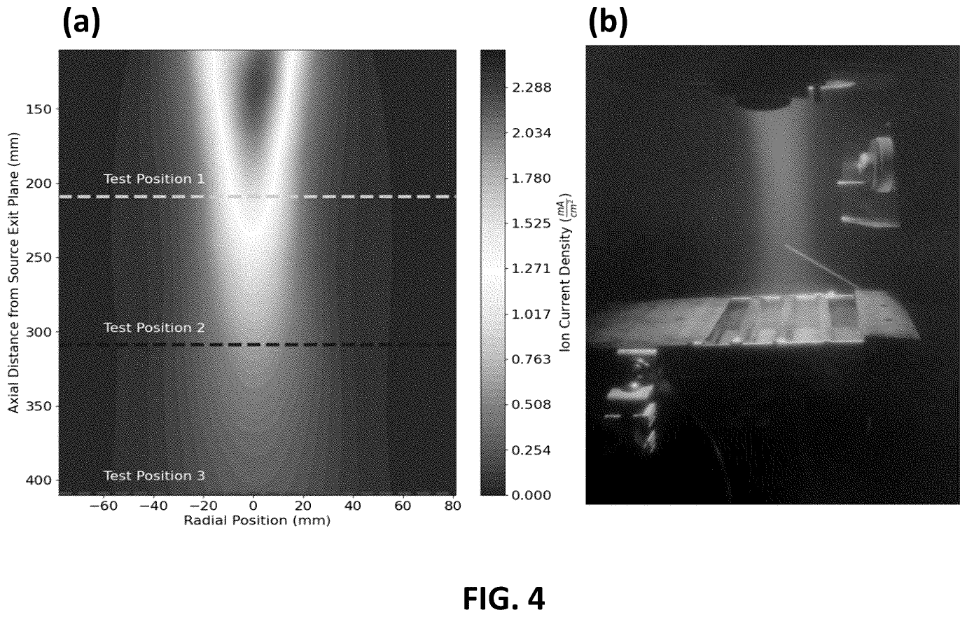

A Faraday probe was utilized to map the ion current density in the regions of interest for halter testing downstream of the ion source. The Faraday probe was translated on a two-dimensional motion stage to measure the axial current density from 110 mm-410 mm axial distance from the source exit plane, and −75 mm to 80 mm in the transverse (radial) direction relative to the ion beam centerline. A typical ion current density map is shown in FIG. 4, part (a). The Halter example I-V measurements were made at three axial locations of 210 mm (Test Position 1), 310 mm (Test Position 2), and 410 mm (Test Position 3), which are shown in part (a) of FIG. 4. A photograph of the halter system under test at test position 1 (210 mm) is shown in part (b) of FIG. 4. The active area of the halter example is large enough to contain the majority of the ion beam at all three test positions.

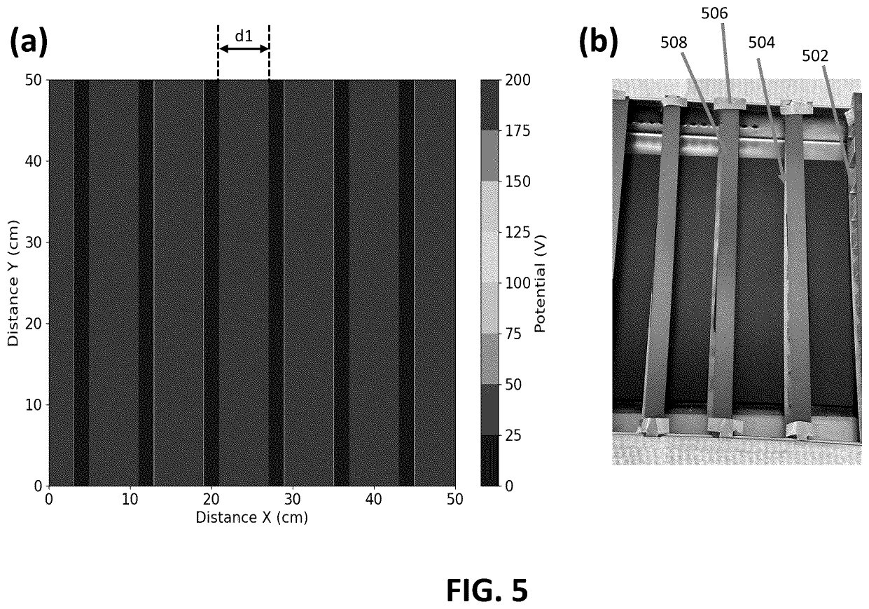

Halter Backsputter Model. The backsputter model includes two sub-models, an ion plume and a sputter model. The ion plume model is used to provide the number of ions and charge-exchange-produced fast neutrals expected to arrive at the surface of a halter system. The sputter model predicts the amount of backsputter material that will arrive back to a thruster or co-located quartz crystal microbalance (QCM) for the given ion and fast neutral energy and angle of incidence. The axial positioning of the Halter system at some location (z) and the relative geometry and features of the Halter system can be adjusted to accommodate several test conditions. For example, a representative 1 m by 1 m halter example was used to predict the expected effectiveness, in terms of backsputter reduction relative to a grounded graphite plate, in the beam of a 1.5 kW Hall thruster (described below). The simulated quarter of the 1 m-by-1 m halter system (i.e., 1 m² halter system) is shown in FIG. 5, part (a). Part (b) of FIG. 5 shows a photograph of the smaller halter example evaluated downstream of a the 8-cm ion source. In part (b) of FIG. 5, grounded graphite strips 508 cover magnets 502. Part (b) of FIG. 5 also shows ground plate retainer brackets 506. The quarter view of the 1 m² halter system (shown in FIG. 5, part (a)) assumes a 2 cm width of the grounded plate and a 6 cm spacing (d1) between the magnets, with the assumed ion energy suppression plate bias at 200V relative to ground.

Hall Thruster Plume Model. To assess the backsputter of facility material to a given thruster, it is necessary to quantify the total sputter-capable fluence to the halter system surfaces. To do this, the current density data of a 1.5 kW Hall thruster was fit to a two-term Gaussian, similar to that used by Pencil et al. The fit provides the current density with respect to radial distance, r, from the face of the thruster centerline and the angle from the thruster centerline, θ. Equation 1—

$$j ( r , θ ) = \frac{{R}^{2}}{{r}^{2}} [ {k}_{0} exp ( - \frac{sin {θ}^{2}}{{k}_{1}^{2}} ) + {k}_{2} exp ( - \frac{{θ}^{2}}{{k}_{3}^{2}} ) ]$$

The parameters k₀, k₁, k₂, and k₃ are fit to current density measurements made on an arc, at some R distance from the thruster. The current fraction of doubly ionized xenon or krypton atoms in the beam is left adjustable but is typically assumed to be 18-20%, which is representative of doubly charged ion current fractions measured in the plume of Hall thrusters. The raw current density measurements are corrected for charge exchange according to equation (2) and use charge-exchange (CEX) cross-section fits from Miller et al. and Hause et al. for xenon and krypton, respectively. Equation 2—

$${j}_{meas} = {j}_{beam} exp ( - {σ}_{CEX} {n}_{0} {z}_{dist} )$$

The fraction of sputter-capable fluence that arrives at the Halter system as a neutral will be unaffected by the ion energy suppression biases, and therefore these particles will sputter with yields akin to surfaces that are unbiased. This aspect of the model allows the examination of the effect of increased facility background pressure on the effectiveness of the halter system. As the background pressure or axial spacing increases, the resultant fraction of sputter capable fluence that is neutral will increase and the effectiveness of the Halter will be reduced because the halter system cannot slow incoming fast neutrals.

Sputter model. The sputter model relies on differential sputter yield estimates and solid angle calculations to predict the rate of back sputtered atoms to the thruster or co-located QCM. The size and axial distance of the halter system from the thruster is used with the beam model to determine the sputter capable fluence energy and angle as well as the solid angle for each sputter location on the discretized Halter area. The solid angle for which the sputtered material will be ejected on a trajectory to deposit on the thruster or QCM is calculated across the simulated quarter plate area. Graphite is a material of interest as it is common practice to use this material for beam dumps and facility wall protection due to its low sputter yield. It is also the material used in the ground plates and ion energy suppression plate in the halter system.

Previous models of backsputter utilized a cosine distribution to approximate the differential sputter yield for convenience and to negate the need for fitting free parameters from semi-empirical fits. At higher ion energies, this is more accurate; however, under cosine behavior is often observed at lower energy ion sputtering, with strong variations in forward and backward sputter yield profiles as the angle of incidence is varied from normal sputtering.

A modified Zhang fit, developed by Yalin et al. based on differential sputter yield fit work by Zhang & Zhang was used to provide a continuous function for the differential sputter yield at each Halter operating condition explored. The modified Zhang fit can more accurately capture the under-cosine, as well as the forward and back sputter behavior observed, which may be critical as ions slowed by the Halter beam catcher are reduced to lower energy values.

The Hall thruster ion plume model provides the number, angle of incidence, and energy of the sputter capable fluence to the halter system. The energy of the incoming ions is assumed to be near that of the anode voltage. If an ion is arriving at the ion energy suppression plate, it is assumed to be slowed by the magnitude of the potential difference between the ion energy suppression plate and ground, ΔE_{reduction}=q(V_{anode}−V_{ion suppression plate}). The assumed energy change may not be exact as considerations of other factors such as true ion energy and sheath potentials near the halter plate may be accounted for, however it does provide an approximate value for initial evaluation of the concept. Fast neutrals produced by CEX collisions are assumed to have no reduction in energy upon striking the ion energy suppression plate.

The modified Zhang equations (3) and (4) below provide the differential sputter yield at a given azimuthal (ϕ) and polar (α) angle as a function of bombarding ion energy E, oblique angle of incidence β, and two free-fitting parameters, the total sputter yield Y(E,β) and characteristic energy E*. Efforts to model this carbon transport require the use of a continuous functions that can provide the differential sputter yields at a given θ and ϕ as a function of the incident ion energy E, and oblique angle of incidence β. To achieve this, the fitting parameters Y and E* are cast in a functional form that captures the behavior across a range of energies and angles of incidence. The differentia yield from the modified Zhang is given by equation (3) below—

$${y}_{MZ} = \frac{Y}{1 - \sqrt{\frac{{E}^{*}}{E}} cos ( β )} \frac{cos ( α )}{π} [ 1 - \frac{1}{4} \sqrt{\frac{{E}^{*}}{E}} ( cos ( β ) γ ( α ) + \frac{3}{2} π sin ( α ) cos ( ϕ ) ) ]$$

and equation (4) below—

$$γ ( α ) = \frac{3 {sin ( α )}^{2} - 1}{{sin ( α )}^{2}} + \frac{{cos ( α )}^{2} ( 3 {sin ( α )}^{2} + 1 )}{2 {sin ( α )}^{3}} ln ( \frac{1 + sin ( α )}{1 - sin ( α )} ) .$$

The relationship between the characteristic energy, E*, and the angle of incidence β and the ion energy E was found to fit well to the following (equation 5)—

$$\frac{{E}^{*} cos ( β )}{{E}_{t h}} = {C ( \frac{E}{{E}_{t h}} )}^{n}$$

by Yalin et al. for molybdenum targets, where the threshold energy Eₜₕ is assumed to be known and the constant C and n were free fitting parameters. For molybdenum in, C and n were fit to 0.8 and 0.75, respectively. This leaves the total sputter yield, Y, as the only unknown for the modified Zhang. Total sputter yield has been shown to be well captured by energy dependent and angularly dependent models and were fit extensively for several material by Yim in 2017. The Eckstein energy dependence sputter yield model includes Eₜₕ to calculate characteristic energy, E*, from equation (5), leaving the fit constants C and n as the only unknowns.

A similar Bayesian parameter estimation approach may be used to fit the constants C and n for the existing graphite data provided by Williams et al., However, initial modeling effort suggested a different form of relating E* to Eₜₕ may be warranted. To obtain preliminary sputter results for purposes evaluating the model, the same fit parameters for C and n were utilized for graphite sputter data. Utilizing these fit parameters, the modified Zhang model differential qualitatively matches the profile of the differential measurements made by Williams et al., and appears to be a much closer approximation for low energy yields than previous cosine-based approaches. Total yield Y(E, β) was provided from the best fit parameters for graphite using the Eckstein energy dependent and Wei angular dependent models.

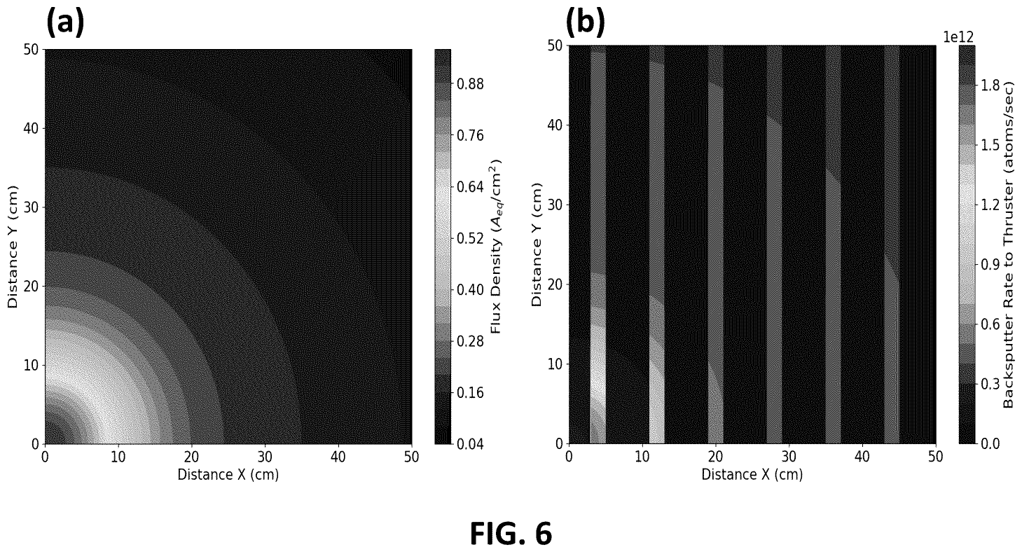

Utilizing the modified Zhang fit for graphite, and the plume model fit to 1.5 kW a Hall thruster, a simulated quarter of the picket fence halter under incident 1.5 kW thruster beam operated at 300V is shown in FIG. 6. Part (a) of FIG. 6 plot shows the predicted sputter-capable fluence to the Halter plate, while part (b) shows the predicted back sputter rate to the thruster face 1 meter away with an assumed ion energy suppression plate voltage of 200V.

The backsputter model may be used to predict how well a given system might be able to reduce the back sputter to a thruster. In the results presented herein, the relative decreases in backsputter rate are compared to that of a grounded graphite plate of the same size in the same location relative to the thruster. Sputtering of facility wall and other surfaces are not currently included in the model, which can become significant contributors to backsputter in large length-to-diameter chambers (L/D).

Halter Current-Voltage Model. A model of the current collected at the halter ion energy suppression plate as a function of applied bias to the plate was developed. Modeling measured characteristics of the halter under different operating conditions enables broader understanding of general trends and may provide insight into recommended operational or design criteria. The general outline of the model is described herein, with results presented below.

The model relates properties at the sheath edge near the plate, denoted s, to the incoming plasma properties, denoted p, at the upstream end of the halter plate. To predict the current to the plate of the halter system both the ion and electron current to the plate are evaluated at each applied ion energy suppression plate bias V. The electron current to the plate can be characterized by a generalized Ohm's law—equation (6)—

$${j}_{e} = E \frac{{q}^{2} {n}_{e}}{{m}_{e}} \frac{{ν}_{c}}{{ω}_{e}^{2} + {ν}_{c}^{2}}$$

where E is the electric field in front of the ion energy suppression plate, q is the fundamental charge, nₑ is the electron density in the plume in front of the halter system, mₑ is the mass of an electron, v_{c} is the classical collision frequency, and ωₑ is the gyrofrequency of the electrons. The electric field is assumed to be linear cross the halter magnetic sector E=V/L, where L is the length of the magnetic section that ions and electrons must travel across to arrive to the plate.

The ion current density is captured by taking the first moment of the ion velocity distribution represented as equation (7)—

$${{j}_{i} = q {n}_{e} {\int }_{0}^{∞} {v}_{s} {f}_{i} ( {v}_{s} ) \vert}_{s} d {v}_{s}$$

where vₛ is the velocity of the ions near the sheath edge. This velocity can be related to incoming velocity of plume ion velocity by applying conservation of energy to derive the characteristic equation (8)—

$${v}_{s} = \sqrt{\frac{2 q}{{m}_{i}} ( {V}_{p} - {V}_{s} ) + {v}_{p}^{2}}$$

where Vₚ is the plasma potential and Vₛ is the sheath potential. The change in the ion energy distribution is characterized by the one-dimension steady-state Vlasov equation (9)—

$$v \frac{\partial {f}_{i}}{\partial x} = - \frac{qE}{{m}_{i}} \frac{\partial {f}_{i}}{\partial v}$$

that can be used to relate the incoming velocity distribution to that at the sheath edge. This solution results in an ion current that is related to the incoming ion energy distribution and potential difference between the sheath and the plasma potential through equation (10)—

$${{j}_{i} = q {n}_{e} {\int }_{{V}_{s} - {V}_{p}}^{∞} {v}_{p} {f}_{i} ( {v}_{p} \to {E}_{p} ) \vert}_{p} d {E}_{p}$$

where ion velocity distribution fᵢ (vₚ)|ₚ is evaluated at the plasma plume. This distribution is assumed to be a low temperature, Tᵢₒₙ=0.5 eV, Maxwellian distribution traveling at the beam speed u_{b} represented as equation (11)—

$${f}_{i} ( v ) = {( \frac{{m}_{i}}{2 π q {T}_{i}} )}^{\frac{1}{2}} {e}^{- \frac{{{m}_{i} ( v - {u}_{b} )}^{2}}{2 q {T}_{i}}}$$

where mᵢ is the mass of the ion, Tᵢ is the ion temperature, and q is the fundamental charge. This velocity distribution can be related to the ion energy distribution through equation (12)—

$${f}_{i} ( v ) = {( \frac{{m}_{i}}{2 π q {T}_{i}} )}^{\frac{1}{2}} {e}^{- \frac{{{m}_{i} ( \sqrt{\frac{2 q {E}_{p}}{{m}_{i}}} - {u}_{b} )}^{2}}{2 q {T}_{i}}}$$

with E_{P} representing the ion energy at the plume prior to entering the Halter system. The ion current density at the plume edge of the device is considered a measured quantity jᵢ. The ion current density that arrives to the plate is the characterized by the fraction of the plume ions that have sufficient energy to overcome the difference between the sheath voltage Vₛ and the plasma potential Vₚ.

Now with equations that relate both ion current density and electron current to sheath voltage and plasma potential, an expression can be written for the total current to the plate as equation (13)—

$${I = A ( {j}_{e} + {j}_{i} ) = {Aqn}_{e} [ E \frac{q}{{m}_{e}} \frac{{ν}_{c}}{{ω}_{e}^{2} + {ν}_{c}^{2}} + {\int }_{{V}_{s} - {V}_{p}}^{∞} {f}_{i} ( {v}_{p} \to {E}_{p} ) \vert}_{p} {dE}_{p} ]$$

Initially only classic collisions are considered through equation (14)—

$${ν}_{c} = 2.9 \times 1 {0}^{- 12} \frac{ln Λ 〈 {n}_{e} 〉}{{( {T}_{e} )}^{3 / 2}}$$

where the Coulomb logarithm, ln Λ, is given by equation (15)—

$$ln Λ = 23 - \frac{1}{2} ln ( \frac{1 {0}^{- 6} 〈 {n}_{e} 〉}{{( {T}_{e} )}^{\frac{3}{2}}} )$$

and where [symbol] nₑ [symbol] is the averaged plasma density in the magnetic sector of the plate. Here it is assumed the average density is the mean of the sheath and plume density

$$〈 {n}_{e} 〉 = \frac{{n}_{e} + {n}_{s}}{2} ,$$

where nₛ is given by equation (16)—

$${{n}_{s} = {n}_{e} {\int }_{0}^{∞} {f}_{i} ( \sqrt{\frac{2 q}{{m}_{i}} ( {V}_{p} - {V}_{s} ) + {v}_{p}^{2}} ) \vert}_{p} d {v}_{p}$$

If it is assumed that the Hall parameter is significantly large, the plasma potential Vₚ is near 0V, and that the sheath potential Vₛ is negligible to that of the ion energy suppression plate bias Vₛ, equation (13) can be rewritten as equation (17)—

$${{I = A ( {j}_{e} + {j}_{i} ) = {Aqn}_{e} [ - \frac{V}{L} \frac{q}{{m}_{e}} \frac{Γ}{{ω}_{e}^{2}} \frac{{n}_{e}}{2 {( {T}_{e} )}^{3 / 2}} [ {\int }_{0}^{∞} {f}_{i} ( \sqrt{{v}_{p}^{2} - \frac{2 q}{{m}_{i}} V} ) \vert}_{p} d {v}_{p} + 1 ] + {\int }_{V}^{∞} {f}_{i} ( {v}_{p} \to {E}_{p} ) \vert}_{p} d {E}_{p} ]$$

Picket-Fence Configuration in a Gridded Ion Source Beam. The picket-fence configuration of the halter system was evaluated in the beam of the 8-cm ion source described herein. The source was mounted to a motion stage that allowed evaluation at three axial locations away from the ion source, 210 mm, 310 mm, and 410 mm, respectively. The current density was mapped across this region with a Faraday probe mounted to a 2D motion stage able to discreetly sweep across several axial and radial locations centered on the gridset centerline. The resulting current density map is shown in FIG. 4, part (a). The ion source was operated at the same beam current for each test, while the beam voltage was varied.

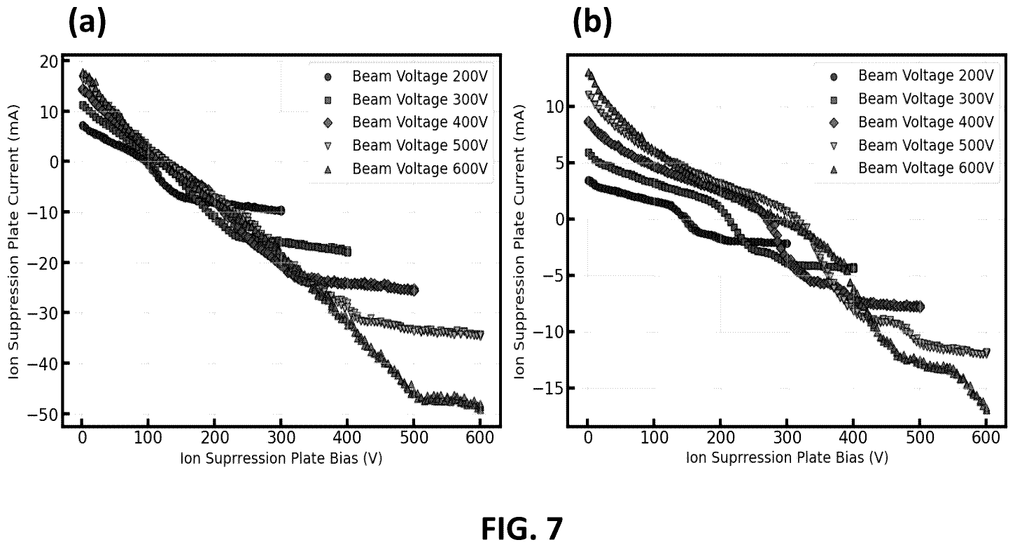

At each location the current to ion energy suppression plate with respect to the applied plate voltage (referred to as the I/V curve) was measured as the ion source was operated at beam voltages from 200V to 600V. The applied bias voltage was swept 100V past the beam voltage in all tests except the 600V operating condition. The current measurement convention used is similar to that of a retarding potential analyzer (RPA), with positive current representing ions arriving at the plate, and negative current indicating net electron current to the plate. The resultant I/V curves for the 210 mm test location are shown in part (a) of FIG. 7, and the resultant I/V curves for 310 mm test location are shown in part (b) of FIG. 7. A fair amount of curve overlap is present in the closest test location (i.e., in the 210 mm test location) with the majority of the curves crossing (zero net current) a floating voltage location within 50V of each other. The slope of the curves indicate that there is a large amount electron current to the plate even at lower voltages as there is no distinct ‘knee’ in the curve that would traditionally represent the ion energy distribution. In the second test location, 310 mm, the lower beam voltage I/V curves begin to separate out with more distinctly different floating voltages for the lower operating beam voltages. In these plots there seems to be a more significant drop in current, indicating decreased ion current, at voltages around 80% of the beam voltage.

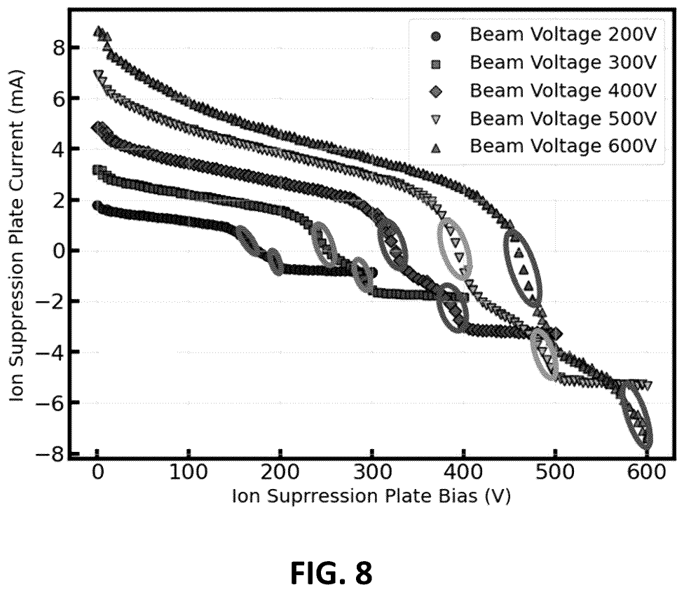

The current collection curves (i.e., I/V curves) at the 410 mm test location, shown in FIG. 8, continues the trend of spreading out of the higher beam voltage conditions. Furthermore, the inflection of each curve, also represented by maximum of the

$$- \frac{dI}{d V} ,$$

indicate two distinct maxima, annotated with circles in FIG. 8. Another distinct feature of the collected currents is the saturation observed at biases above the beam voltage for all test conditions, except 600V as it was not swept to sufficiently high biases to observe the same trend.

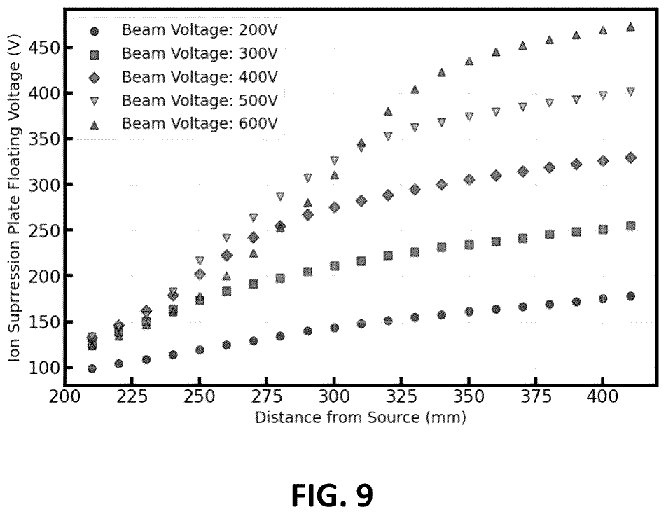

If the Halter ion energy suppression plate can achieve floating voltages sufficiently high to reduce sputtering, then little to no power would be used to operate the system. Furthermore, minimal input power to the halter system may result in the least amount of plume interaction. As noted in the I/V curves presented in FIG. 7 and FIG. 8, it was observed that the floating voltage was increased as the halter system was moved further downstream of the ion source. As a result, the halter ion energy suppression plate floating voltage was measured while the system was moved from 210-410 mm downstream of the source to observe the overall trend of floating voltage. The resulting floating voltage profiles for each beam voltage are shown in FIG. 9. A clear trend towards saturation was in regions that would be considered far field, or greater than 4 thruster diameters downstream, is observed. However, the near field locations at higher voltages seem to have a significant amount of electron current, thereby limiting the floating voltage.

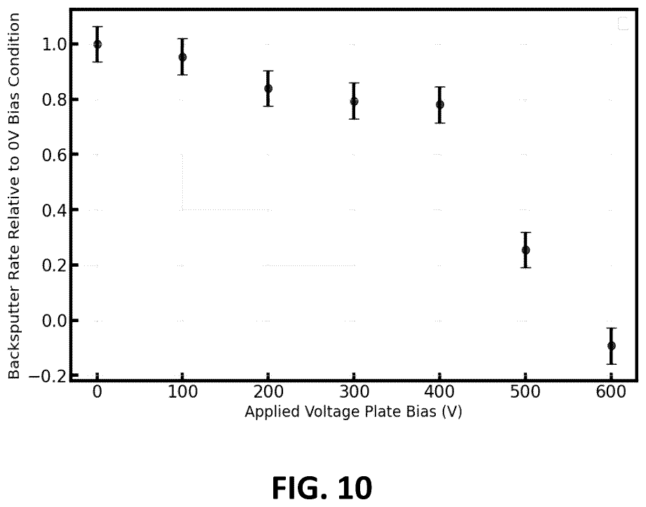

A limited backsputter test was conducted utilizing a quartz crystal microbalance (QCM) mounted near the ion source but tilted to face the Halter system. The QCM was monitored with an IMM-200 deposition rate monitor to evaluate relative changes to the backsputter rate as the ion energy suppression plate was varied. FIG. 10 shows how the backsputter rate changed with applied bias relative to the observed rate with a 0V bias applied at the 310 mm location. The uncertainty in the measurement is based on the repeatability of the 0V bias condition across the length of the test. The QCM was water cooled and allowed to reach thermal equilibrium at each condition before changing biases. The QCM measurement indicated net erosion at the 600V condition.

The backsputter model was leveraged to determine expected effectiveness of different halter configurations and operating conditions. Two features of interest to evaluate were the effects of pressure on the system effectiveness and the impact of reduced open area fractions. To do this, the plume model was fit to a representative current density profile of a 1.5 kW Hall thruster. The sputter model was then applied to the specified halter configuration. For all model results presented herein, the halter system was assumed to be 1.5 m away from the thruster face and was assumed to be 1 m by 1 m with the center of the plate aligned with thruster centerline as shown in FIG. 5. In each test, the thruster was assumed to operate in two different anode voltages—300V and 600V respectively.

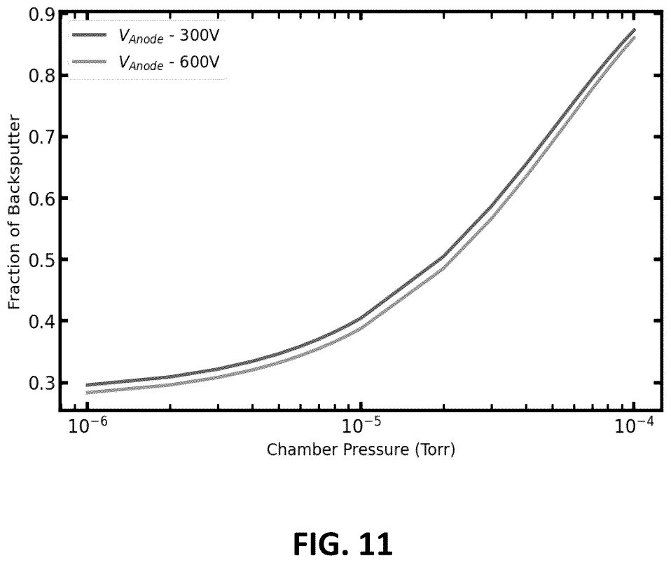

In the evaluation of pressure effects on halter operation, the ion energy suppression plate was assumed to be held 80% of the anode voltage, which floating voltage measurements of the example from FIG. 9 indicate is reasonable. Calculations for the backsputter rate were repeated for a range of pressures 1E-6 Torr to 1E-4 Torr. As pressure increases, the fraction of the sputter capable fluence that will arrive to the halter system as a neutral with assumed beam velocities will increase. This increase in fast moving neutrals arriving to the halter will, in turn, reduce the overall system effectiveness as neutral species are unresponsive to the applied electrostatic fields. This effect is shown clearly in FIG. 11 as the expected reduction in backsputter decreases from around 30% that of a grounded plate while operated at low pressure up to nearly no reduction at 1E-4 Torr.

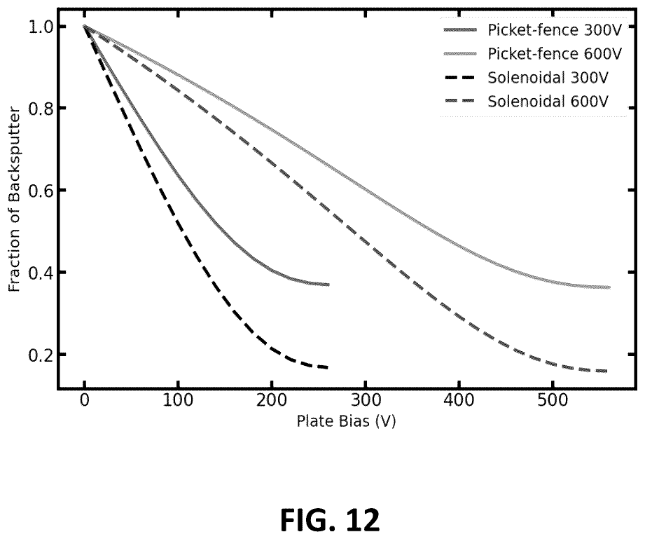

Another feature to explore is the effect of open area fraction of the halter system. The open area fraction can influence the strength of the magnetic field as spacing between magnets or solenoid structures often limit achievable field strength for a given strength of magnet or size of solenoid. Sufficient magnetic field strength is used to avoid plume interactions that could affect test fidelity. The solenoidal configuration of the Halter may allow the suspension of a plate behind the transverse magnetic field with few if any grounded surfaces in the path of the beam ions. FIG. 12 shows the expected effectiveness of the halter system utilizing a scaled picket-fence and solenoidal configurations, with open area fractions of about 75% and 100%, respectively. FIG. 12 shows, for each of the scaled picket-fence and solenoidal configurations, simulated fraction of backsputtered material at two operating voltages of 300V and 600V with respect to the applied ion energy suppression plate bias relative to a grounded graphite plate with no magnetic field. Although the plate manages to capture the majority of the ion beam current the achievable effectiveness is still limited by the presence fast neutrals present at finite background pressures assumed to be 1E-5 Torr for the results presented in FIG. 12.

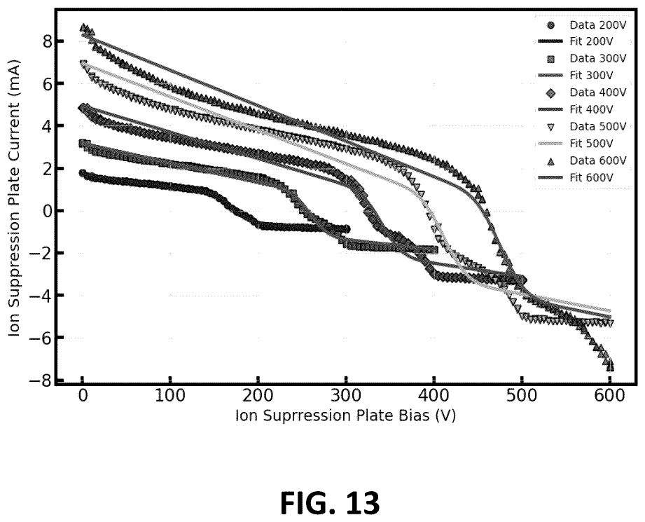

Halter Current-Voltage Characteristic Model. The current-voltage model of the halter was fit to I/V curve measurements of the example picket-fence Halter configuration. Parameters of the model can then be adjusted to observe the expected effects that changes in operating condition might have on a halter system. Parameters to define values for are the length L of the magnetic sector (perpendicular to the plate) and the average strength of the transverse magnetic field, B which was assumed to be near 450 Gauss across weakest 6 mm long section of the sector. The incoming beam ion current density was taken from the current density mapping FIG. 4, with slight adjustments made for each different beam voltage condition. The area of the current density collection was assumed to increase with increasing distance downstream to capture nearly the same current, after correcting for CEX, at each location. However, due to the two groups of ions observed in FIG. 8, the energy of the beam ions was allowed to be a free fitting parameter. Early fits seem to indicate that a larger electron current was also warranted to accurately fit, so an additional collisional term v_{α} was added to enable increased electron current for better fit results. This is discussed in further detail below. FIG. 13 shows the best fits of the model to each of the experimentally captured curves at the 410 mm axial location. The lower beam voltage conditions appear to fit better to the model while more disagreement is present between the model and higher voltage measurements, however, it is worth noting that the 600V condition did not contain plate biases above the beam voltage, that would have helped increase agreements at higher plate voltages.

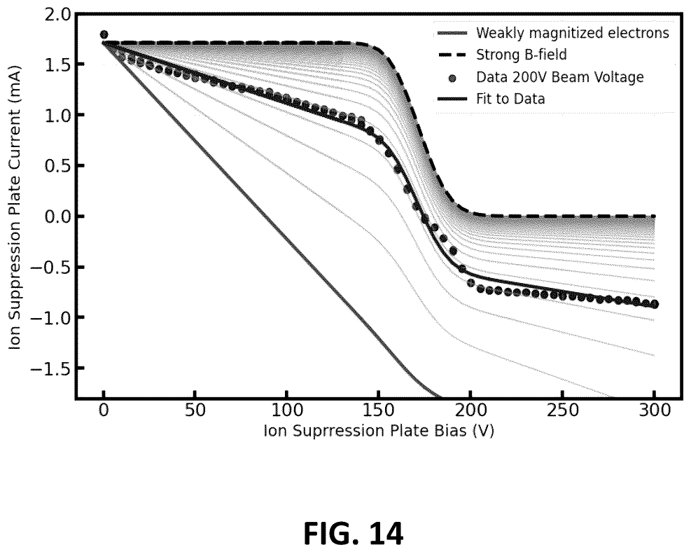

The 200V beam condition had the best fit and was therefore used to evaluate the effect of operation under various conditions. FIG. 14 shows the fit to the 200V condition but with examples of what the model predicts would happen with better and worse confinement of electrons by the magnetic fields. In this comparison the v_{α} term was assumed to remain unchanged with increasing or decreasing magnetic field strength, although this is likely not the expected behavior. The strong B-field curve is representative of a scenario similar to an ideal Retarding potential analyzer (RPA) where net ion current is collected with no electron current, until sufficient voltage is achieved to repel ions and leave a near zero current. This would be the ideal I/V curve of the halter as the floating voltage would remain high enough to operate the system without the need to externally bias the ion energy suppression plate. However, the weakly magnetized electron case seems to follow that of the data collected closer to the ion source at 210 m and 310 mm test locations.

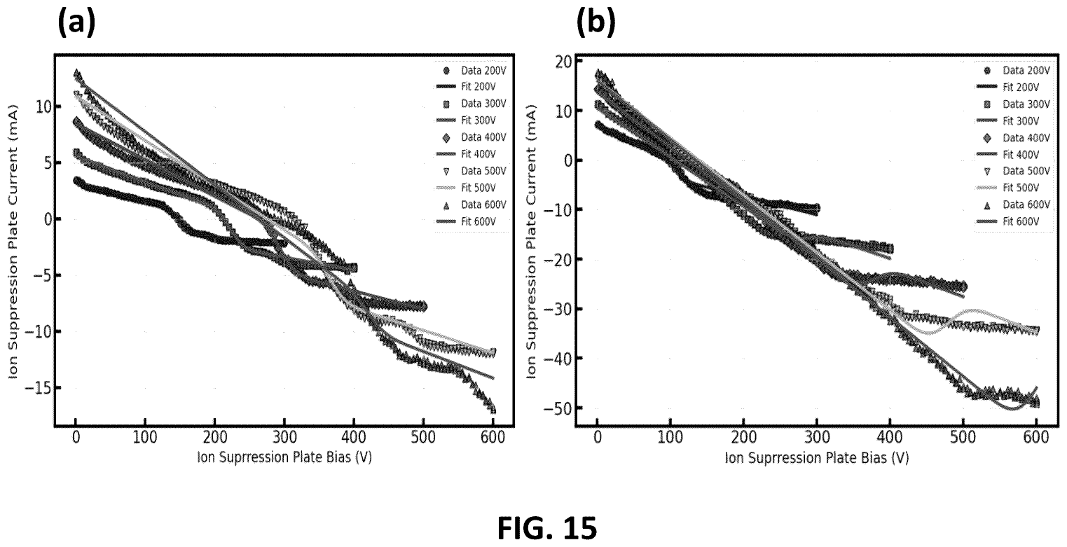

The model had a difficult time fitting to the experimentally collected I/V curves at the closer locations if the B-field was forced to remain near the measured values even with significant v_{α} values. However, if weaker B-field values were permitted, by an order of magnitude, then the general shape of the I/V curves could be fit by the model. FIG. 15 shows the fits to these curves with weaker B-fields allowed. Part (a) of FIG. 15 shows fits to the 310 mm experimentally collected I/V curves and part (b) of FIG. 15 shows fits to the 210 mm experimentally collected I/V curves.

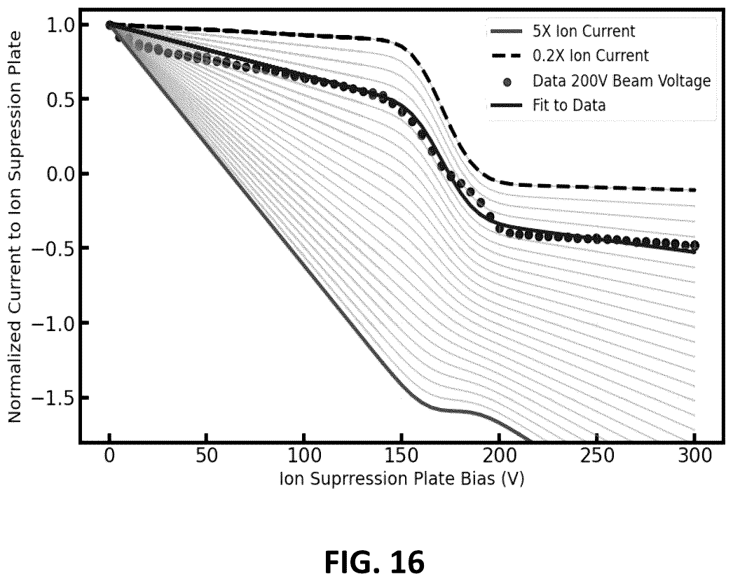

The model can also be used to examine the effects of increased ion current density to the halter plate, as application in high power testing is likely to result in dramatically increased ion current densities. FIG. 16 shows a similar fit the 200V data at 410 mm downstream but with 0.2× and 5× adjustments to the measured ion current density assuming no changes in the rest of the halter configuration. The normalized current density is used to better compare these trends, but a clear reduction in the floating voltage is observed at increased ion current densities.

Described hereinabove are systems and methods for reducing backsputter to electric propulsion thrusters by slowing down beam ions. The disclosed systems may be referred to as a “beam-catcher”. In some cases, the beam-catcher is configured as a “Hall thruster in reverse” or a halter that utilizes transverse magnetic fields to the surface a positively biased plate downstream of an electric propulsion device with the goal of slowing incoming beam ions to the plate. This slowing aims to reduce the sputter of material by incident beam ions that are subsequently deposited back on the thruster. To evaluate the effectiveness of the disclosed system, sputter and current-voltage models of the system were developed. An example of the picket-fence configuration halter system was tested in the beam of an 8-cm ion source to compare to initial sputter and current-voltage models.

Further details regarding the disclosed systems and methods for mitigating backsputter during Hall thruster testing are described below in connection with FIGS. 18-29. The disclosed systems and methods are used to mitigate carbon back sputter during the testing of a 4.5 kW Hall effect thruster. The strategy is based on a beam halter employing a crossed electric and magnetic field configuration to slow high-energy energy ions quasi-neutrally before they impact a graphite plate. A one meter square device example is tested with the graphite plate floating at four different thruster conditions, and the graphite plate biased with a power supply at one condition. At each floating condition, the magnetic field of the beam halter was swept from 0 to 115 G. A quartz crystal microbalance mounted in plane is used to monitor back sputter from the target. As described below, testing of the example system indicates that a larger beam halter placed farther downstream may enhance back sputter mitigation.

Accurate ground testing of electric propulsion (EP) devices is useful to ensuring in-flight reliability and performance. Facility effects, such as back sputtered material onto thruster surfaces, can change the performance and hide wear rates of the thruster relative to an in-space environment. Back sputter occurs when a high-energy ion from the thruster collides with a downstream surface, releasing material. To help mitigate this, electric propulsion test facilities are lined with graphite, a low sputter yield material. While graphite-lined chambers reduce the back sputter over other materials, the observed rates can still be high enough to cloud measurements.

Carbon back sputter is particularly an issue for the lifetime qualification of Hall thrusters, the most widely flown type of EP device. Hall thrusters utilize a combination of electric and magnetic fields to ionize and accelerate a plasma to produce thrust. The advent of magnetic shielding has extended Hall thruster lifetimes to >10,000 hours and shifted the main erosion mechanism from the channel to the graphite pole pieces. After the pole covers are eroded, integral Hall thruster components like the magnetic circuit are exposed to plasma bombardment, which effectively ends thruster life. Many efforts have made progress in modeling and understanding the physics of the pole erosion process, but currently, models are still not predictive. Therefore, experimental qualification tests are typically used to determine thruster lifetime. During these tests, deposited graphite from the facility onto the pole covers can cause uncertainty in the true wear rate and thus overall thruster lifetime. Additionally, as Hall thrusters are scaled to higher powers to meet mission needs, the rate of carbon back sputter will increase, further complicating lifetime qualifications.

As described herein, to solve this problem, the back sputter is mitigated before it can deposit on thruster surfaces. For instance, a combination of electric and magnetic fields may be used to slow down the high-energy ion beam before it reaches the sputtering target. The ion energy may be reduced to below the sputtering yield for graphite, and back sputter is eliminated. To accomplish this, an electromagnetic “beam halter” is described herein. The beam halter uses a strong transverse magnetic field in front of a graphite plate to impede electron motion. If the graphite plate is left floating, the voltage will increase to balance the flux of ions and electrons. The resulting electric field from the voltage drop between the plate and the main plume will retard the ion motion to, ideally, below the sputtering yield. Alternatively, the plate may be biased beyond the floating voltage to slow ion motion further if it does not significantly impact the properties of the plume and thereby create an additional facility effect.

As described above, an example electromagnetic beam halter was constructed and configured to slow down an ion beam. The example device was tested across different ion energies and at different distances from the ion source. The results indicated that the plate voltage floated sufficiently positive to be capable of slowing down the beam.

Described below in connection with FIGS. 18-29 is a larger example of the beam halter to slow down the beam of a Hall thruster.

The beam halter is configured to slow down high-energy ions before they impact downstream thruster surfaces. A diagram to illustrate the beam halter principle of operation is shown in FIG. 18. Ions are accelerated from the thruster in a quasi-neutral plasma with an average ion energy of V_{b}. As the plasma approaches the beam halter, the transverse magnetic field (\vec{B}) impedes electron motion to a graphite plate 1806 due to the small mass of the electrons. Since the electrons are trapped in the magnetic field, the initial flux of ions to the plate is greater than the electron flux, which increases the voltage of the plate 1806. Thus, in some cases, the plate 1806 may not be initially or externally biased. The growing voltage at the plate 1806 produces an electric field (\vec{E}) to retard the ion motion so that the electron and ion flux are balanced. Ideally, the energy of the ions is reduced below the sputtering threshold of graphite (about 30 V for xenon) so that back sputter is eliminated. Therefore, the beam halter may have a sufficiently strong transverse magnetic field to impede electron flux.

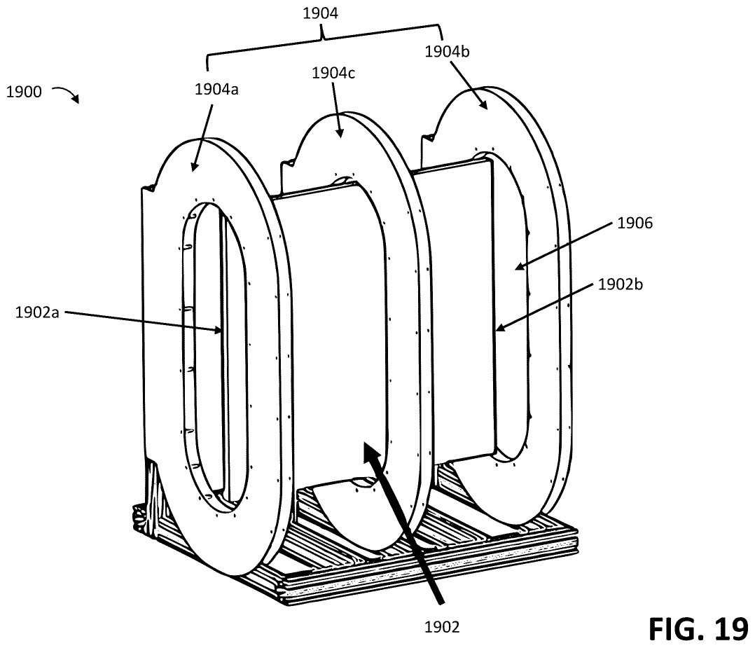

An example configuration of a beam halter 1900 is shown in FIG. 19. The beam halter 1900 is configured to produce a strong, uniform magnetic field parallel to a graphite panel 1902 (or plate) to impede electron motion toward the panel 1902. The beam halter 1900 may also be configured such that ion trajectories to the plate 1902 are not blocked or such that blocked ion trajectories to the plate 1902 are minimized or reduced. Any ions that collide with the beam halter 1900 and are not slowed down by the plate potential may produce back sputter and negate the device's effectiveness.

As shown in FIG. 19, the beam halter 1900 may have a geometry inspired by a Helmholtz coil, with three solenoids 1904 surrounding the graphite plate 1902. The number of solenoids may vary in other cases. The graphite panel 1902 and other aspects of the beam halter 1900 may be sized to take up 100% of the ion beam. However, in this example, a smaller scale was used to take up about 60% of the beam. The transparency of the solenoids 1904 to the plate 1902 (e.g., the area of the plate 1902 not covered by the solenoids 1904) may be greater than 90%. Using the equations set forth hereinabove, it was estimated that to sufficiently impede electrons, a magnetic field on the order of a Hall thruster (e.g., about 100 G) would be useful. In this smaller scale example, the graphite plate 1902 was 2 ft×2 ft and was mounted about 2.5 thruster diameters downstream using ceramic stand-offs (not shown) to isolate the plate 1902 from the rest of the beam halter 1900. The solenoids 1904 were sized and configured to be pill-shaped with the inner cutout 1906 having a width of 11 in and a length of 26 in, with 600 turns of 14 gauge polyamide-imide coated wire in each solenoid, and the wire having a current rating in power transmission of about 5-7 A. In this example, one solenoid 1904c was placed in the middle of the graphite plate 1902 and the other two solenoids 1904a, 1904b were disposed along respective sides of the plate 1902. The gap between the solenoids was 11.5 in. Therefore, the only graphite area blocked by a solenoid is from the downstream face of the middle coil 1904c, which covers about 6.25% of the graphite panel.

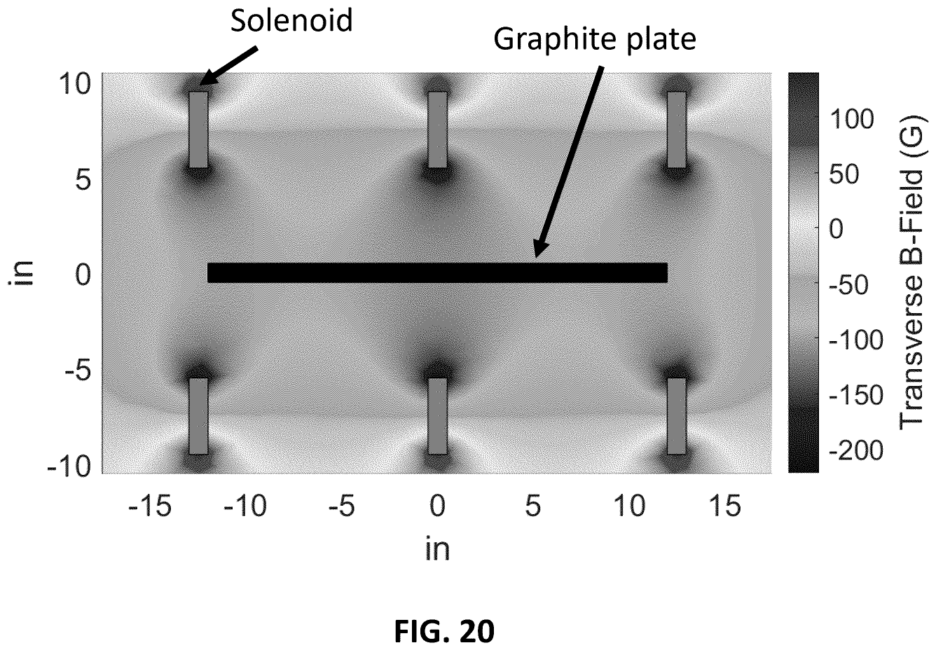

An AC/DC module was used in COMSOL Multiphysics to simulate the steady-state magnetic field of the solenoids 1904 with a coil current of 5 A. Each solenoid 1904a, 1904b, 1904c was modeled as a homogenized multi-turn conductor with 3000 Amp turns (600 turns of 5 A). FIG. 20 shows a top-down view of the transverse magnetic field strength. The field strength in the area between the coils (solenoids) is predicted to be no less than about 90 G at 5 A.

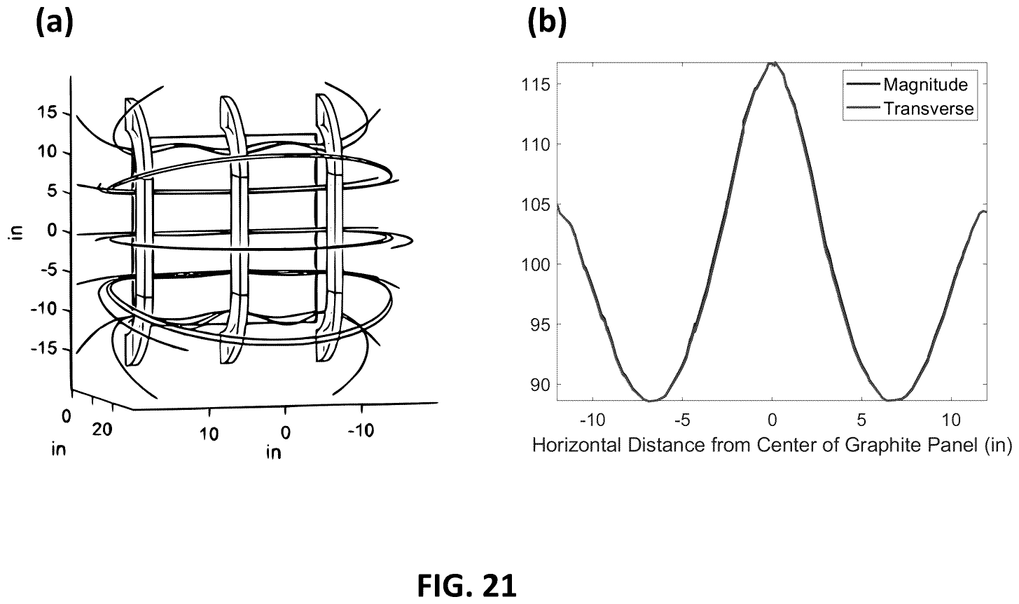

The magnetic field streamlines are plotted in FIG. 21, part (a). The field is primarily transverse inside the beam halter, with the field lines running parallel to the plate. This conclusion is supported by FIG. 21, part (b), which shows the close alignment of the magnitudes of the transverse field component and the overall field in the region between the solenoid and the graphite plate.

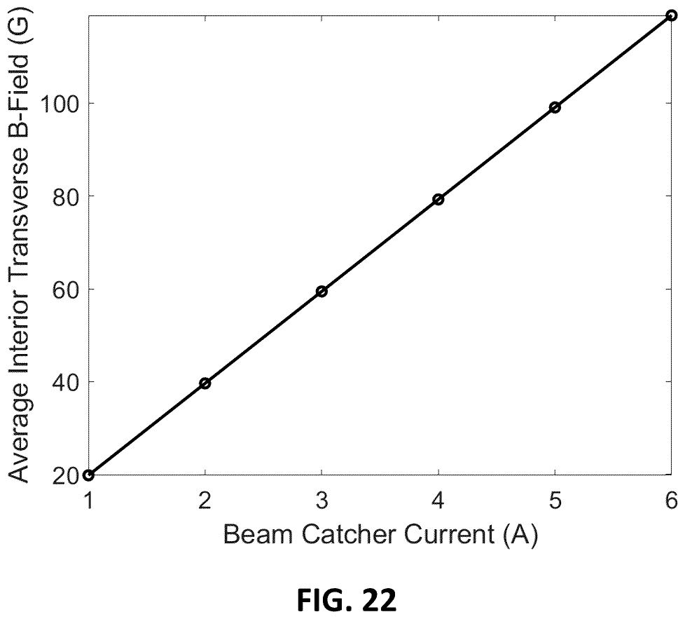

In FIG. 22, the average transverse component of the magnetic field strength in FIG. 21, part (b), is plotted for different solenoid currents. Because there is no ferromagnetic material present, the magnetic field is linear with the input current. At solenoid currents greater than 5 A, the average magnetic field is greater than 100 G, which may sufficiently impede electron motion.

The example beam halter was tested using an H9 Hall thruster, a 9 kW class magnetically shielded laboratory Hall thruster. The H9 employs a centrally mounted lanthanum hexaboride (Lab6) cathode. The discharge chamber is made of boron nitride, the anode is made of stainless steel, and there are two graphite pole covers that protect the thruster poles. The magnetic circuit utilizes a “magnetically shielded” field topology to reduce energetic ion bombardment of the walls. The nominal discharge current of the H9 is 15 A, with discharge voltages from 200 V to 600 V. In this testing, the thruster is operated on krypton at 300 V, 15 A.

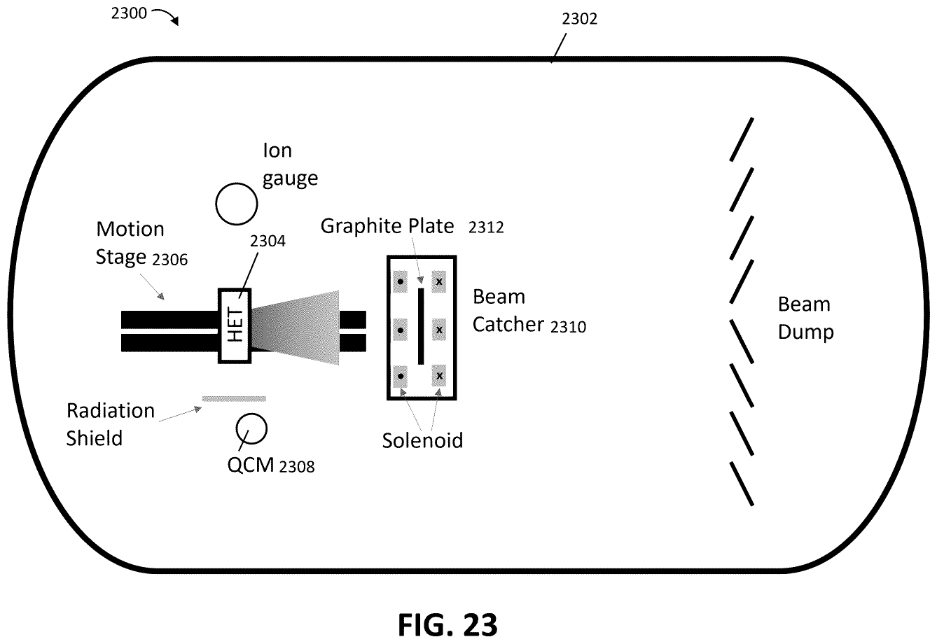

FIG. 23 shows a top-down schematic of the Alec D. Gallimore Large Vacuum Test Facility (LVTF) 2300 at the University of Michigan. The LVTF 2300 includes a 6 m diameter by 9 m steel chamber 2302 with 17 cryopumps. It has a nominal pumping speed of 600,000 L/s on krypton. At 300 V, 15 A with the H9 on krypton, the nominal in-plane background pressure is 4.8 μTorr-Kr. During operation, a thruster 2304 was centrally mounted in the chamber 2302 on an axial motion stage 2306 and fired downstream. A beam halter (beam catcher 2310) was positioned at a nominal distance of 2.5 thruster diameters downstream (e.g., distance to a graphite plate 2312). The axial stage 2306 was used to move the thruster a maximum of about 1 thruster diameter backward.

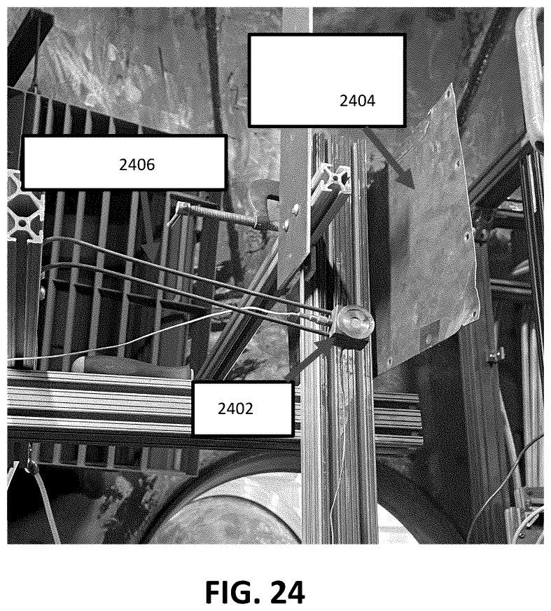

To analyze the effectiveness of the beam halter 2310, a quartz crystal microbalance (QCM) 2308 with an Inficon XTC/3 controller was used to measure the back sputter. The QCM 2308 was mounted about 0.6 m away from the center of the thruster 2304 in a position to ensure that the back sputter from the graphite plate was captured. A picture of the QCM is shown in FIG. 24.

FIG. 24 shows a QCM 2402 mounted with a radiation shield 2404 and active cooling assembly 2406 to maintain thermal stability.

To accurately measure the carbon back sputter, the active cooling assembly 2406 and the radiation shield 2404 were used to try to keep the QCM 2402 thermally stable. The QCM 2402 typically increased in temperature with the thruster and beam halter during the five minute acquisition period for each condition. To try to mitigate the error introduced by the changing frequency, the acquisition was divided into minute-long sub-samples. The rate for each sub-sample was then calculated and averaged to estimate the back sputter rate.

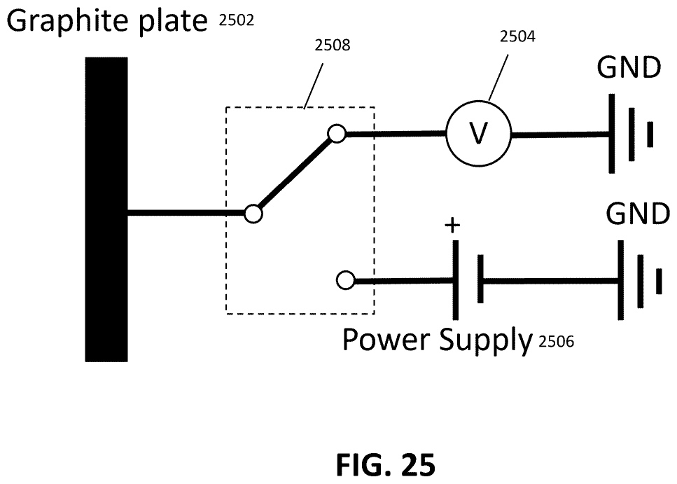

FIG. 25 shows a circuit diagram of a graphite plate 2502 and a circuit configured to either float or bias the plate 2502. The graphite plate 2502 may be grounded or connected to a power supply 2506 to bias the graphite plate 2502. In this example, the electrical configuration of the graphite plate 2502 may be switched between a floating configuration and a biased configuration. To that end, the electrical configuration of the graphite plate 2502 may be switched between the two configurations via a two-way switch 2508. When floating, a voltmeter 2504 was used to measure the floating voltage. To bias the plate, the graphite plate 2502 is switched from the ground to the power supply 2506. A TDK-Lambda 100 V, 15 A power supply was used as the power supply 2506. Because this power supply 2506 provided current, it was used to bias the plate 2504 higher than the floating voltage. This guaranteed that only electron current was collected and avoided damage to the supply.

Table 1 presents the various thruster configurations and operating conditions tested with the beam halter. The thruster was operated in four different configurations with the graphite plate floating, and one condition with it biased. The standard configuration was at 300 V, 15 A with the cathode and body floating independently, and the plate 2.5 thruster diameters downstream. With the plate floating, it was also operated with a discharge voltage of 200 V, with the plate 3.5 thruster diameters away, and with the cathode tied to the body. At each condition, the solenoid current in the beam halter was varied from 0 to 6 A. Each solenoid current was maintained for five minutes and incrementally increased by 1 A. Data was collected at 0 A before and after the current sweep at each operating condition to assess variability in the deposition rate and thruster performance. The average of these two measurements in the deposition rate with the solenoids off were calculated. The plate was biased from 40 V to 80 V in increments of 10 V, with the solenoid current at 5 A. Similar to the floating data, each condition was maintained for five minutes. Data was collected with the plate unbiased and a solenoid current of 0 A before and after the sweep. The back pressure measured by the ion gauge during testing was about 7 μTorr-kr at all conditions. This is 1.5 times higher than reported previously for the same thruster in the LVTF.

TABLE 1

| Configuration | Discharging | Plate | Plate Distance | Cathode |
|---|---|---|---|---|
| Name | Voltage (V) | Configuration | (D_{T}) | Configuration |
| 300 V | 300 | Floating | 2.5 | Floating |
| 200 V | 200 | Floating | 2.5 | Floating |
| 300 V far field | 300 | Floating | 3.5 | Floating |
| 300 V body tied | 300 | Floating | 2.5 | Body tied |
| 300 V biased | 300 | Biased | 2.5 | Floating |

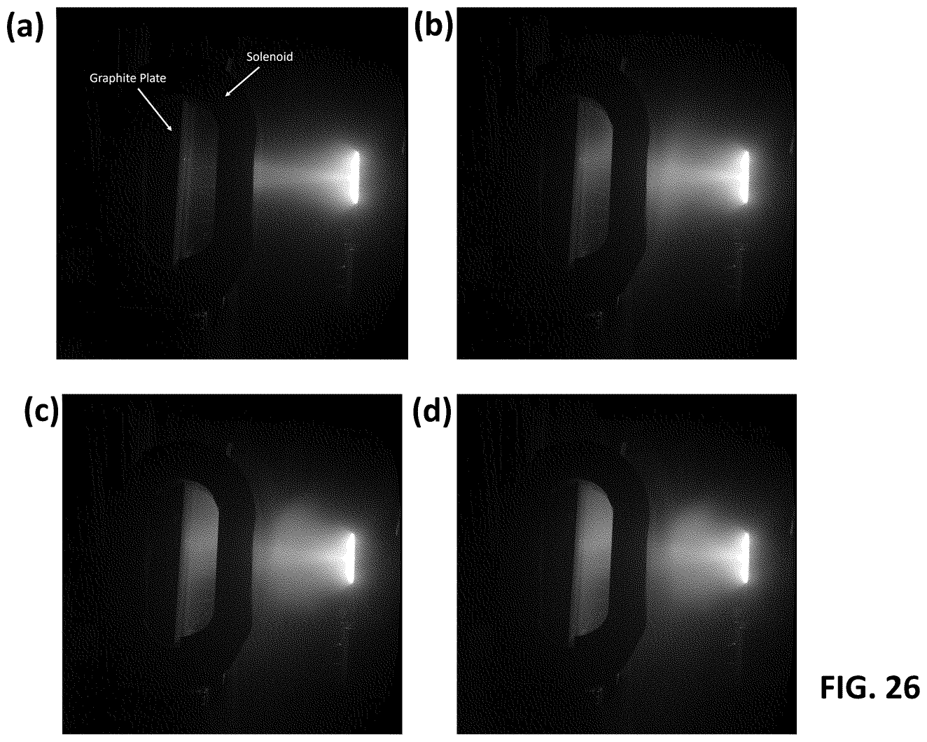

FIG. 26 shows the beam halter in operation at different solenoid currents. FIG. 26, part (a) shows operation of the beam halter with a coil current of 0 A. FIG. 26, part (b) shows operation of the beam halter with a coil current of 2 A. FIG. 26, part (c) shows operation of the beam halter with a coil current of 4 A. FIG. 26, part (d) shows operation of the beam halter with a coil current of 6 A. The thruster is operated on krypton at 200 V, 15 A with the graphite plate floating. As the solenoid current (magnetic field strength) increases, the purple glow in the gap between the solenoid and plate is more pronounced. Indeed, by 6 A the glow fills up almost the entire gap. The glow may be due to neutral excitation. The higher solenoid currents likely impede the motion of the ions more, increasing the neutral recombination rate and thus density near the graphite plate. This enhances the neutral excitations, making the glow in between the solenoid and gap brighten. The plume of the thruster also visibly changes. This is likely due to the magnetic field outside of the solenoid having a larger sphere of influence at higher coil currents.

The test results with the graphite plate floating are now provided, including the floating voltage, cathode-to-ground voltage, back sputter rate, and QCM heating rate. As presented in Table 1, the test system was operated at four different conditions with the beam dump floating and the solenoid current varied from 0 to 6 A at each. As summarized in Table 1, the nominal thruster operating condition is on krypton at 300V, 15 A, with both the cathode and body floating independently and the beam halter at about 2.5 thruster diameters downstream of the exit plane. The test system was operated at a discharge voltage of 200 V, with the thruster at 3.5 thruster diameters away, and with the cathode tied to the body.

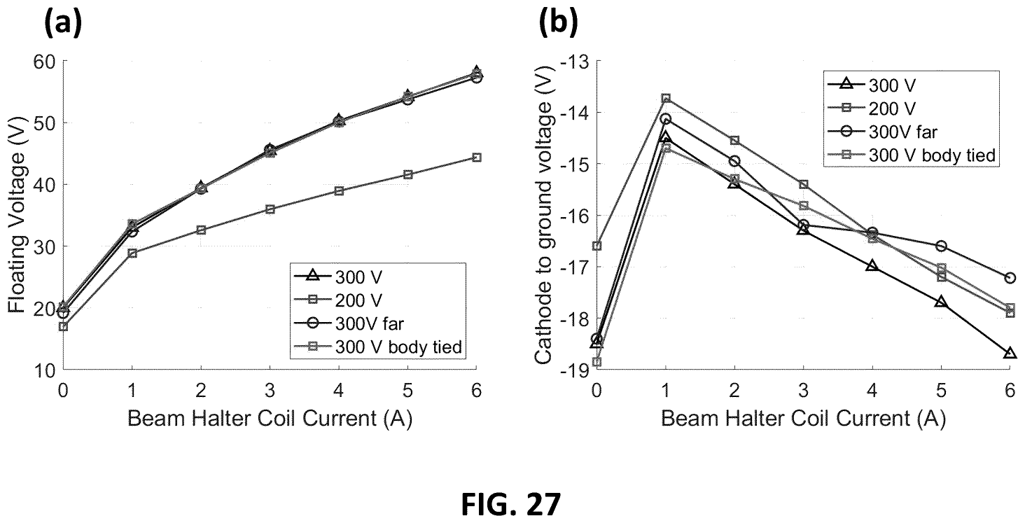

In FIG. 27, part (a), the floating voltage of the plate with respect to cathode are plotted, and in FIG. 27, part (b) cathode to ground voltage are plotted as a function of solenoid current. In part (a) of FIG. 27, the floating voltage of the plate (referenced with respect to the cathode) monotonically increases with solenoid current for all four operating conditions. As the magnetic field increases with solenoid current, it impedes the electron motion to the plate more. This in turn causes the voltage of the plate to increase to slow down the ion motion so that the fluxes are balanced. For the three conditions with the thruster at 300 V, the floating voltage follows an almost identical trend. The maximum floating voltage with a discharge voltage of 300 V is 58 V. At the 200 V condition, the floating voltage is lower at all solenoid currents than the 300 V conditions. The maximum floating voltage at 200 V is 44 V. The floating voltage may be on the order of the discharge to further slow down the ions.

The cathode to ground voltage with the beam dump floating as a function of solenoid current is plotted in FIG. 27, part (b). The cathode-to-ground voltage was used as a metric for the impact of the beam halter on the thruster. This quantity may remain unchanged with the beam halter on. All four conditions follow a similar trend, with an increase in the cathode to ground voltage with the solenoids at 1 A by about 4 V, followed by a monotonic decrease from 1 A to 6 A. At a solenoid current of 5-6 A, the cathode to ground voltage is close to its normal operating value (within 1-2 V of nominal (i.e., magnetic field off)). This indicates that at sufficiently high magnetic field strengths, the beam halter is likely not significantly impacting Hall thruster performance.

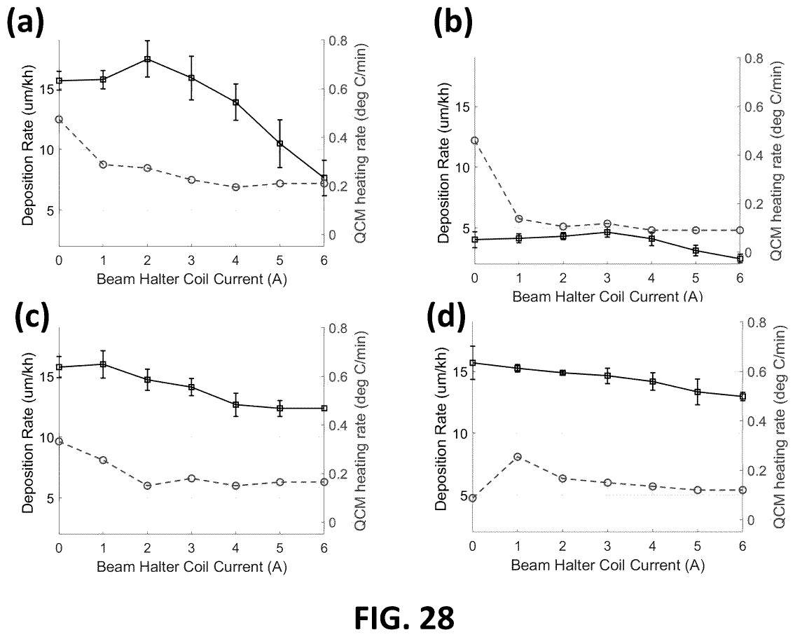

In FIG. 28, the deposition rate measured by the QCM and the heating rate of the QCM for four configurations in Table 1, i.e., 300 V in part (a), 200 V in part (b), 300 V far field in part (c), 300 V body tied in part (d), are plotted as a function of solenoid current and with the plate floating. In general, for all four cases, the back sputter rate decreases with increasing field strength. Because the floating voltage increases with solenoid current (as shown in FIG. 27, part (a)), the average energy with which the ions impact the surface should decrease accordingly, reducing back sputter. This effect is more pronounced in FIG. 28, part (a) (300 V case), than in the other three cases. This is unexpected because the floating voltage for all 300 V cases is almost the same. Because the mechanism for back sputter reduction is the electric field from the plate, one would expect the back sputter to be similar across these cases. The reasons for this potentially anomalous result are discussed below. The back sputter rate at 200 V is lower at all conditions than at 300 V because the ions, on average, are born with a smaller energy. This in turn leads to less graphite sputtered per atom, as observed.

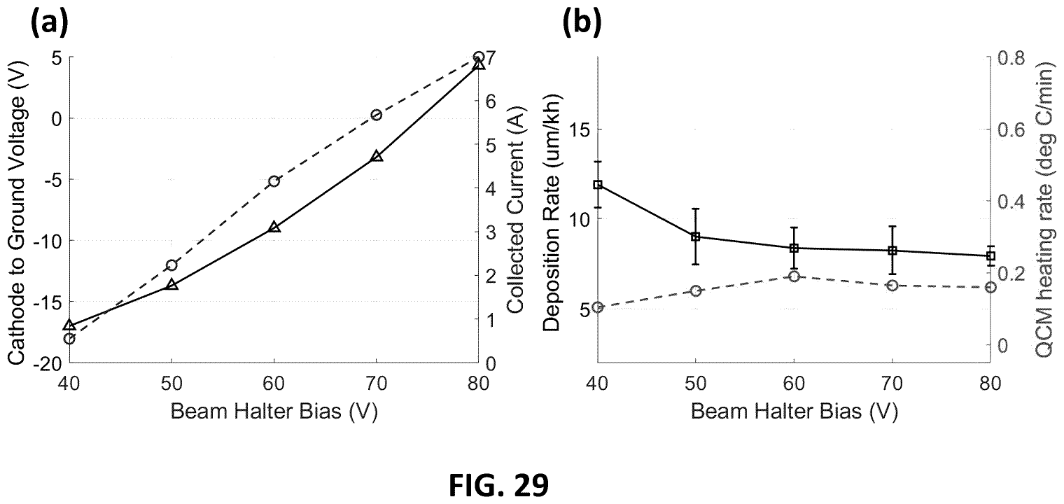

The results from operation while biasing the graphite panel (i.e., 300 V bias configuration in Table 1) are now provided. The solenoid current was kept at 5 A. The bias voltage was swept from 40 to 80 V in increments of 10V. In FIG. 29, part (a), the cathode-to-ground voltage is plotted (with black solid line) and overlaid with the collected current at the graphite panel (with blue dashed line) as a function bias voltage. Note that in contrast to the floating voltage in FIG. 27, part (a), the bias voltage is ground referenced.

At 5 A, the floating voltage at 300 V with respect to ground is about 36 V. As the bias voltage is increased beyond this, the electron current monotonically increases, similar to a standard Langmuir probe. At 80 V, about 7 A of electron current was collected, which is just under half of the discharge current. This high current is largely due to the size of the graphite plate, which was chosen to subtend greater than 50% of the beam.

The cathode-to-ground voltage also monotonically increases with beam halter bias. Previous studies have shown a similar shift in biasing a beam dump past its floating voltage. This indicates that biasing the beam dump is affecting the thruster's electrical configuration. With that being said, a 10 V increase in the beam halter bias corresponds to less than a 10 V increase in the cathode-to-ground voltage. This highlights that although the plume is floating positively, the overall ion energy at the plate is reduced with higher plate bias.

In FIG. 29, part (b), the deposition rate is plotted with black solid line, and the QCM heating rate is plotted with red dashed line. As seen in FIG. 29, part (b), the reduction in ion energy at the plate corresponds to a decrease in back sputter rate with bias voltage. It appears that the largest reduction is from 40-50 V. From 50 to 80 V, the average back sputter does decrease, but the amount of reduction is within the measurement uncertainty.

Described above are examples of systems and methods for mitigating backsputter from high energy ions impacting downstream surfaces in the facility that can otherwise deposit back on the thruster and cloud accurate erosion estimates. As Hall thrusters are scaled to higher powers, the backsputter rate grows proportionally. To attempt to mitigate this backsputter, the operation of an example electromagnetic beam halter positioned downstream of a Hall thruster was tested. As described above, the beam halter produces a strong transverse magnetic field in front of a graphite plate. This reduces the electron mobility to the plate and subsequently increases the plate potential to balance the ion and electron flux. The high plate potential then generates an electric field that slows down the ions and reduces backsputter. In the example tested, the beam halter surrounds a 2×2 ft graphite panel and is capable of producing transverse fields greater than 110 G.

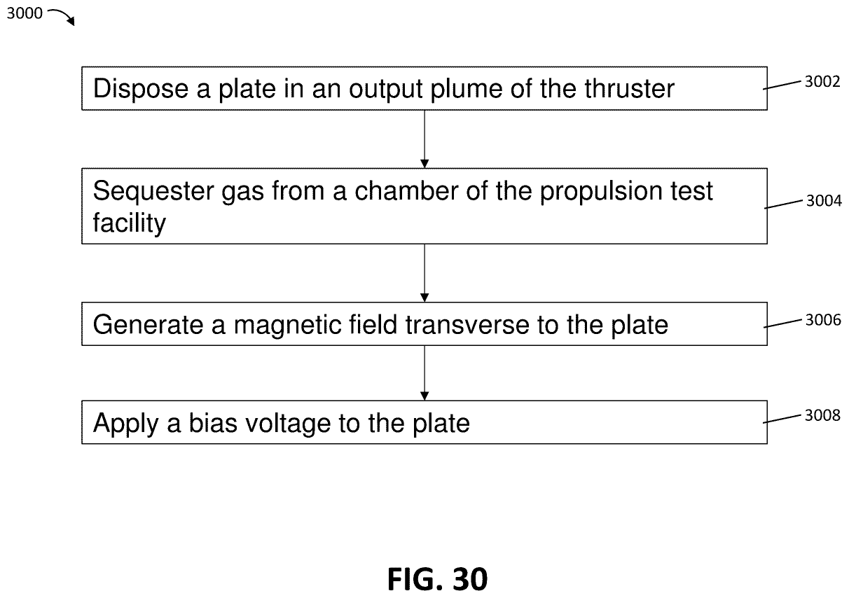

FIG. 30 is a flow chart to describe a method 3000 for mitigating backsputter to a thruster in a propulsion test facility in accordance with some embodiments. The method 3000 may be performed using any one of the halter systems described above, for example, the halter system 150, 200, 1900, and the propulsion test facility described above, for example, the LVTF 2300. However, the method 3000 may be performed using other halter systems and propulsion test facilities. The method 3000 may include fewer, additional, or alternative acts. The order of the acts may also vary from that shown.

At block 3002, a plate of the halter system may be disposed in an output plume of the thruster within a propulsion test facility. The plate may be disposed perpendicular to an axis of the output plume. In some cases, disposing the plate in the output plum of the thruster may include orienting the plate at a non-perpendicular angle to an axis of the output plume. In some cases, the plate is disposed apart from the thruster by an axial distance falling in a range that corresponds to about 1 thruster diameter to about 10 thruster diameters.

At block 3004, gas in the chamber of the propulsion test facility is sequestered from a chamber in which the thruster and the halter system are disposed. Sequestering the gas may reduce the impact caused by gas within the chamber or to maintain a required test condition.

At block 3006, a magnetic field generator of the halter system generates a magnetic field transverse to the plate to slow ions form the thruster before the ions impact the plate. The magnetic field generator may generate the magnetic field parallel to the plate in front of the plate (i.e., between the source of the output plume of the thruster and the surface of the plate). In some cases, the magnetic field may have a magnitude sufficient to trap electrons in the output plume. In some other embodiments, the magnetic field has a magnitude insufficient to trap ions in the output plume. When using a “picket-fence” magnetic configuration halter, the magnetic field generator may include a plurality of magnets disposed about the plate. In some cases, the plurality of magnets are disposed such that two or more magnetic rows face one another. When using a solenoidal configuration, the magnetic field generator may include one or more solenoids disposed at or about the plate. During operation, the magnetic field may be tailored such that the ions are unaffected (e.g., not diverted) while the electrons are affected (e.g., diverted). In some cases, the magnetic field has a magnitude falling in a range between about 0 Gauss to about 200 Gauss.

At block 3008, a power supply may apply a bias voltage to the plate. The bias voltage may be greater than the floating voltage of the plate generated by the magnetic field when it is electrically floated.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A system for mitigating backsputter to a thruster in a propulsion test facility, the system comprising:
a plate disposed in an output plume of the thruster; and
a magnetic field generator disposed about or at the plate and configured to generate a magnetic field between the thruster and the plate;
wherein the magnetic field generator is oriented such that the magnetic field is transverse to the output plume.

2. The system of claim 1, wherein the magnetic field generator comprises a plurality of solenoids disposed about the plate.

3. The system of claim 1, wherein the magnetic field has a magnitude sufficient to trap electrons in the output plume.

4. The system of claim 1, wherein the magnetic field has a magnitude insufficient to trap ions in the output plume.

5. The system of claim 1, wherein the magnetic field has a magnitude falling in a range between 0 Gauss to about 200 Gauss.

6. The system of claim 1, wherein the plate is electrically floating.

7. The system of claim 1, wherein the plate is spaced from the thruster by an axial distance falling in a range that corresponds to about 1 thruster diameter to about 10 thruster diameters.

8. The system of claim 1, further comprising a power source coupled to the plate to electrically bias the plate.

9. The system of claim 1, wherein the plate is oriented perpendicularly to an axis of the output plume.

10. The system of claim 1, wherein the plate is oriented at a non-perpendicular angle to an axis of the output plume.

11. The system of claim 1, wherein the magnetic field generator comprises a plurality of permanent magnets.

12. The system of claim 1, wherein the magnetic field generator is oriented such that the magnetic field is parallel to a surface of the plate.

13. A method for mitigating backsputter to a thruster in a propulsion test facility, the method comprising:
disposing a plate in an output plume of the thruster; and
generating a magnetic field between the thruster and the plate;
wherein the magnetic field is transverse to the output plume.

14. The method of claim 13, wherein generating the magnetic field comprises driving a plurality of solenoids disposed about the plate.

15. The method of claim 13, further comprising applying a bias voltage to the plate.

16. The method of claim 13, wherein disposing the plate comprises orienting the plate at a non-perpendicular angle to an axis of the output plume.

17. The method of claim 13, further comprising sequestering gas from a chamber of the propulsion test facility.
